(19) United States
(12) Patent Application Publication
(10) Pub. No.: US 2026/0333135 A1
(43) Pub. Date: Oct. 22, 2026

(54) ARTIFICIAL INTELLIGENCE MACHINE LEARNING ENABLEMENT (AIMLE) SERVER DISCOVERY AND SERVICE MIGRATION

(71) Applicant: Lenovo (United States) Inc., Morrisville, NC (US)

(72) Inventor: Roozbeh Atarius, La Jolla, CA (US)

(73) Assignee: Lenovo (United States) Inc., Morrisville, NC (US)

(21) Appl. No.: 19/672,341

(22) Filed: May 8, 2026

(51) Int. Cl. H04W 36/00; H04W 84/04

(52) U.S. Cl. CPC H04W 36/0016; H04W 36/0033; H04W 84/042

(57) ABSTRACT

Various aspects of the present disclosure relate to artificial intelligence machine learning enablement (AIMLE) server discovery and service migration. A source AIMLE server transmits, to a machine learning (ML) repository via a server discovery request operation, a cross-public land mobile network (PLMN) AIMLE server discovery request indicating criteria for AIMLE server discovery for an AIMLE client associated with a user equipment (UE) moving to a visited PLMN, and receives a server discovery response including a first list of AIMLE servers based at least in part on the criteria. The source AIMLE server transmits, via a server change trigger operation, a server change trigger request including the first list, receives a server change trigger response indicating a second list comprising a subset of the first list, and transmits a server change complete message indicating an AIMLE server selected from the second list.

### TECHNICAL FIELD

The present disclosure relates to wireless communications, and more specifically to service migration for artificial intelligence (AI) and machine learning (ML) operations.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C).

As used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, a “set” may include one or more elements.

The devices (e.g., NE, UE), processors, and methods of the present disclosure each have several innovative aspects, no single one of which is solely responsible for the desirable features disclosed herein. In view of the foregoing, particular combinations of features may be recited in the claims or described in the present disclosure, such combinations are not intended to limit the scope of the aspects described herein. Features described in connection with one aspect may be combined with features of other aspects, even if such combinations are not expressly recited in the claims or expressly described in the present disclosure. The disclosure of the various aspects should be understood to include each dependent claim in combination with each other claim in the claim set, to the extent such combinations are technically feasible.

A source artificial intelligence machine learning enablement (AIMLE) server for wireless communication is described. The source AIMLE server may be configured to, capable of, or operable to perform one or more operations as described herein. For example, the source AIMLE server may be configured to, capable of, or operable to transmit, to a machine learning (ML) repository via a custom server discovery request operation, a cross-public land mobile network (PLMN) AIMLE server discovery request indicating one or more parameters for AIMLE server discovery for an AIMLE client associated with a UE moving to a visited PLMN, receive, from the ML repository, a server discovery response including a first list of AIMLE servers available in the visited PLMN based on the one or more parameters, transmit, to the AIMLE client via a custom server change trigger operation, a server change trigger request including the first list of AIMLE servers, receive, from the AIMLE client, a server change trigger response indicating a second list of AIMLE servers including a subset of the first list of AIMLE servers, and transmit, to the AIMLE client via a custom server change complete operation, a server change complete message indicating an AIMLE server selected from the second list of AIMLE servers.

A processor (e.g., a standalone processor chipset, or a component of a source AIMLE server) for wireless communication is described. The processor may be configured to, capable of, or operable to perform one or more operations as described herein. For example, the processor may be configured to, capable of, or operable to transmit, to an ML repository via a custom server discovery request operation, a cross-PLMN AIMLE server discovery request indicating one or more parameters for AIMLE server discovery for an AIMLE client associated with a UE moving to a visited PLMN, receive, from the ML repository, a server discovery response including a first list of AIMLE servers available in the visited PLMN based on the one or more parameters, transmit, to the AIMLE client via a custom server change trigger operation, a server change trigger request including the first list of AIMLE servers, receive, from the AIMLE client, a server change trigger response indicating a second list of AIMLE servers including a subset of the first list of AIMLE servers, and transmit, to the AIMLE client via a custom server change complete operation, a server change complete message indicating an AIMLE server selected from the second list of AIMLE servers.

A method performed or performable by a source AIMLE server for wireless communication is described. The method may include transmitting, to an ML repository via a custom server discovery request operation, a cross-PLMN AIMLE server discovery request indicating one or more parameters for AIMLE server discovery for an AIMLE client associated with a UE moving to a visited PLMN, receiving, from the ML repository, a server discovery response including a first list of AIMLE servers available in the visited PLMN based on the one or more parameters, transmitting, to the AIMLE client via a custom server change trigger operation, a server change trigger request including the first list of AIMLE servers, receiving, from the AIMLE client, a server change trigger response indicating a second list of AIMLE servers including a subset of the first list of AIMLE servers, and transmitting, to the AIMLE client via a custom server change complete operation, a server change complete message indicating an AIMLE server selected from the second list of AIMLE servers.

In some implementations of the source AIMLE server, the processor, and the method described herein, the source AIMLE server, the processor, and the method may further be configured to transmit, to the AIMLE server and a vertical application layer (VAL) server, the server change complete message as part of the custom server change complete operation. In some implementations of the source AIMLE server, the processor, and the method described herein, the custom server discovery request operation, the custom server change trigger operation, and the custom server change complete operation are custom application programming interface (API) operations without associated resources. In some implementations of the source AIMLE server, the processor, and the method described herein, the cross-PLMN AIMLE server discovery request further indicates a requester identifier identifying the source AIMLE server. In some implementations of the source AIMLE server, the processor, and the method described herein, the server discovery response further includes information associated with AIMLE-supported tasks.

In some implementations of the source AIMLE server, the processor, and the method described herein, the server change trigger request further indicates at least one of an AIMLE service identifier, one or more UE identifiers, a roaming PLMN identifier, or a type of AIMLE service continuity. In some implementations of the source AIMLE server, the processor, and the method described herein, the server change trigger request further includes context information associated with the first list of AIMLE servers, the context information including at least one of a server capability, a coverage area, a load and energy status, or a server ranking. In some implementations of the source AIMLE server, the processor, and the method described herein, the source AIMLE server, the processor, and the method may further be configured to select the AIMLE server from the second list of AIMLE servers based on the context information. In some implementations of the source AIMLE server, the processor, and the method described herein, the server change complete message further indicates at least one of an AIMLE client identifier, one or more UE identifiers, a roaming PLMN identifier, or a type of AIMLE service continuity.

In some implementations of the source AIMLE server, the processor, and the method described herein, the one or more parameters include at least one of a geographical area, a server capability, a load and energy efficiency, or a server ranking. In some implementations of the source AIMLE server, the processor, and the method described herein, the source AIMLE server, the processor, and the method may further be configured to receive, from the AIMLE client, an indication of mobility of the UE to an area covered by the visited PLMN, and the cross-PLMN AIMLE server discovery request is transmitted based on the indication of mobility.

An AIMLE client for wireless communication is described. The AIMLE client may be configured to, capable of, or operable to perform one or more operations as described herein. For example, the AIMLE client may be configured to, capable of, or operable to receive, from a source AIMLE server via a custom server change trigger operation, a server change trigger request including a first list of AIMLE servers available in a visited PLMN, where the AIMLE client is associated with a UE moving to the visited PLMN, transmit, to the source AIMLE server, a server change trigger response indicating a second list of AIMLE servers including a subset of the first list of AIMLE servers, and receive, from the source AIMLE server via a custom server change complete operation, a server change complete message indicating an AIMLE server selected from the second list of AIMLE servers.

A processor (e.g., a standalone processor chipset, or a component of an AIMLE client) for wireless communication is described. The processor may be configured to, capable of, or operable to perform one or more operations as described herein. For example, the processor may be configured to, capable of, or operable to receive, from a source AIMLE server via a custom server change trigger operation, a server change trigger request including a first list of AIMLE servers available in a visited PLMN, where the AIMLE client is associated with a UE moving to the visited PLMN, transmit, to the source AIMLE server, a server change trigger response indicating a second list of AIMLE servers including a subset of the first list of AIMLE servers, and receive, from the source AIMLE server via a custom server change complete operation, a server change complete message indicating an AIMLE server selected from the second list of AIMLE servers.

A method performed or performable by an AIMLE client for wireless communication is described. The method may include receiving, from a source AIMLE server via a custom server change trigger operation, a server change trigger request including a first list of AIMLE servers available in a visited PLMN, where the AIMLE client is associated with a UE moving to the visited PLMN, transmitting, to the source AIMLE server, a server change trigger response indicating a second list of AIMLE servers including a subset of the first list of AIMLE servers, and receiving, from the source AIMLE server via a custom server change complete operation, a server change complete message indicating an AIMLE server selected from the second list of AIMLE servers.

In some implementations of the AIMLE client, the processor, and the method described herein, the custom server change trigger operation and the custom server change complete operation are custom API operations without associated resources. In some implementations of the AIMLE client, the processor, and the method described herein, the AIMLE client, the processor, and the method may further be configured to connect to the AIMLE server for service migration. In some implementations of the AIMLE client, the processor, and the method described herein, the AIMLE client, the processor, and the method may further be configured to detect mobility of the UE to an area covered by the visited PLMN, and transmit, to the source AIMLE server, an indication of the mobility, where the server change trigger request is received based on the indication of the mobility.

An ML repository for wireless communication is described. The ML repository may be configured to, capable of, or operable to perform one or more operations as described herein. For example, the ML repository may be configured to, capable of, or operable to receive, from a source AIMLE server via a custom server discovery request operation, a cross-PLMN AIMLE server discovery request indicating one or more parameters for AIMLE server discovery, and transmit, to the source AIMLE server, a server discovery response including a first list of the AIMLE servers available in a visited PLMN based on the one or more parameters.

A processor (e.g., a standalone processor chipset, or a component of an ML repository) for wireless communication is described. The processor may be configured to, capable of, or operable to perform one or more operations as described herein. For example, the processor may be configured to, capable of, or operable to receive, from a source AIMLE server via a custom server discovery request operation, a cross-PLMN AIMLE server discovery request indicating one or more parameters for AIMLE server discovery, and transmit, to the source AIMLE server, a server discovery response including a first list of the AIMLE servers available in a visited PLMN based on the one or more parameters.

A method performed or performable by an ML repository for wireless communication is described. The method may include receiving, from a source AIMLE server via a custom server discovery request operation, a cross-PLMN AIMLE server discovery request indicating one or more parameters for AIMLE server discovery, and transmitting, to the source AIMLE server, a server discovery response including a first list of the AIMLE servers available in a visited PLMN based on the one or more parameters.

In some implementations of the ML repository, the processor, and the method described herein, the custom server discovery request operation is a custom API operation without associated resources. In some implementations of the ML repository, the processor, and the method described herein, the one or more parameters include at least one of a geographical area, a server capability, a load and energy efficiency, or a server ranking.

A target AIMLE server for wireless communication is described. The target AIMLE server may be configured to, capable of, or operable to perform one or more operations as described herein. For example, the target AIMLE server may be configured to, capable of, or operable to receive, from a source AIMLE server via a custom server change complete operation, a server change complete message indicating an AIMLE server change for an AIMLE client from the source AIMLE server to the target AIMLE server, and establish a connection with the AIMLE client for service continuity.

A processor (e.g., a standalone processor chipset, or a component of a target AIMLE server) for wireless communication is described. The processor may be configured to, capable of, or operable to perform one or more operations as described herein. For example, the processor may be configured to, capable of, or operable to receive, from a source AIMLE server via a custom server change complete operation, a server change complete message indicating an AIMLE server change for an AIMLE client from the source AIMLE server to the target AIMLE server, and establish a connection with the AIMLE client for service continuity.

A method performed or performable by a target AIMLE server for wireless communication is described. The method may include receiving, from a source AIMLE server via a custom server change complete operation, a server change complete message indicating an AIMLE server change for an AIMLE client from the source AIMLE server to the target AIMLE server, and establishing a connection with the AIMLE client for service continuity.

In some implementations of the target AIMLE server, the processor, and the method described herein, the custom server change complete operation is a custom API operation without associated resources.

### BRIEF DESCRIPTION OF THE DRAWINGS

FIG. 1 illustrates an example of a wireless communications system in accordance with aspects of the present disclosure.

FIGS. 2 through 6 illustrate example signaling diagrams, in accordance with aspects of the present disclosure.

FIG. 7 illustrates an example of a UE in accordance with aspects of the present disclosure.

FIG. 8 illustrates an example of a processor in accordance with aspects of the present disclosure.

FIG. 9 illustrates an example of an NE in accordance with aspects of the present disclosure.

FIG. 10 illustrates a flowchart of a method performed by a UE in accordance with aspects of the present disclosure.

FIGS. 11 through 13 illustrate flowcharts of methods performed by an NE in accordance with aspects of the present disclosure.

### DETAILED DESCRIPTION

A wireless communications system may implement application-layer frameworks and functions that enable AI/ML capabilities for devices and services. For example, a wireless communications system may implement an AIMLE framework that supports AI/ML model training and inference operations at UEs and network entities. The AIMLE framework may include AIMLE servers that provide AI/ML services to AIMLE clients operating at devices (e.g., UEs), as well as AI/ML repositories that store and manage information about available AIMLE servers and AI/ML models. An AIMLE client may refer to a software component or function at a UE that interfaces with an AIMLE server to request and manage AI/ML operations. A vertical application layer (VAL) application may refer to an application associated with a vertical industry use case, such as vehicle-to-everything (V2X) communication, public safety, or industrial automation, among other examples. The AIMLE client at the UE may connect to an AIMLE server to perform AI/ML model training and/or inference operations based on requests from the VAL application.

In some scenarios, a device, such as a UE, performing an AI/ML operation (e.g., model training or inference) via an AIMLE client may roam from a home PLMN to a visited PLMN while the AI/ML operation is ongoing. When the UE roams, the AIMLE client may lose connectivity to the AIMLE server in the home PLMN. As used herein, a source AIMLE server refers to the AIMLE server currently serving the AIMLE client (e.g., in the home PLMN), and a target AIMLE server refers to an AIMLE server in the visited PLMN to which the AIMLE service may be migrated. The loss of connectivity to the source AIMLE server may result in disruption of the AI/ML service. To prevent service disruption, the AIMLE service may be migrated from the source AIMLE server to a target AIMLE server in the visited PLMN. This migration involves identifying a target AIMLE server in the visited PLMN that is capable of supporting the ongoing AI/ML operation (e.g., in terms of computational capability, coverage, and available resources), as well as coordinating the AIMLE server change among multiple entities (e.g., the source AIMLE server, the AIMLE client, an AI/ML repository, and the target AIMLE server).

Conventional systems and techniques lack mechanisms to implement AIMLE service migration. For example, existing approaches rely on a server change trigger response that only indicates a positive or negative result, which may not provide sufficient information for the source AIMLE server to determine a target AIMLE server (e.g., based on the AIMLE client's preferences). Without defined signaling and operations, the source AIMLE server may be unable to discover available AIMLE servers in a visited PLMN, to trigger the AIMLE client to participate in server selection, or to notify the AIMLE client and the target AIMLE server of the completed migration. The entities involved in the AIMLE service migration are thus unable to exchange relevant information necessary for changing AIMLE servers, causing interruptions in AIMLE service and ongoing AI/ML operations.

Accordingly, the techniques described herein provide API implementations and custom operations for AIMLE service migration. The API implementations include a first API between the source AIMLE server and the AI/ML repository, and a second API between the source AIMLE server and the AIMLE client, the target AIMLE server, and the VAL server. The custom operations include a server discovery request operation, a server change trigger operation, and a server change complete operation. These operations are implemented as custom operations without associated resources, utilizing data structures that carry information such as server identifiers, discovery criteria, context information, and service continuity type information. The server discovery request operation utilizes the first API, while the server change trigger operation and the server change complete operation utilize the second API.

When a source AIMLE server determines that a UE associated with an AIMLE client is moving to a visited PLMN, the source AIMLE server initiates a service migration procedure to maintain continuity of the AI/ML operation according to the described techniques. The source AIMLE server transmits, to an AI/ML repository via the server discovery request operation, a cross-PLMN AIMLE server discovery request indicating criteria for discovering AIMLE servers in the visited PLMN. The criteria include attributes or characteristics of AIMLE servers that define suitability for serving the AIMLE client in the visited PLMN, such as server capabilities, geographic coverage, operational efficiency, historical performance, and the like, among other examples. The AI/ML repository may respond with a list of available AIMLE servers that match the criteria. The source AIMLE server may then transmit, to the AIMLE client via the server change trigger operation, a server change trigger request that includes the list of available AIMLE servers. The AIMLE client may down-select from the list and respond with a subset of the available AIMLE servers. The source AIMLE server may select a target AIMLE server from the subset and transmit, to the AIMLE client via the server change complete operation, a server change complete message indicating the selected target AIMLE server. The source AIMLE server may also notify the target AIMLE server and a VAL server of the migration. The target AIMLE server and the AIMLE client may establish a connection with one another to maintain service continuity.

The described techniques provide mechanisms for AIMLE service migration and improve continuity of AI/ML operations when a UE roams to a visited PLMN. By defining a first API between the source AIMLE server and the AI/ML repository, and a second API between the source AIMLE server and the AIMLE client, the target AIMLE server, and the VAL server, the techniques described herein provide a structured interface for coordinating the service migration across multiple entities. Further, by implementing the server discovery request operation, the server change trigger operation, and the server change complete operation as custom operations without associated resources, the described techniques reduce signaling overhead and processing complexity relative to resource-based API approaches, as the operations do not require creation, storage, or management of persistent resources at the API endpoints. Additionally, reusing the second API and the server change complete operation to notify both the AIMLE client and the target AIMLE server and the VAL server may reduce the number of distinct API interfaces and operations required for the migration procedure.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

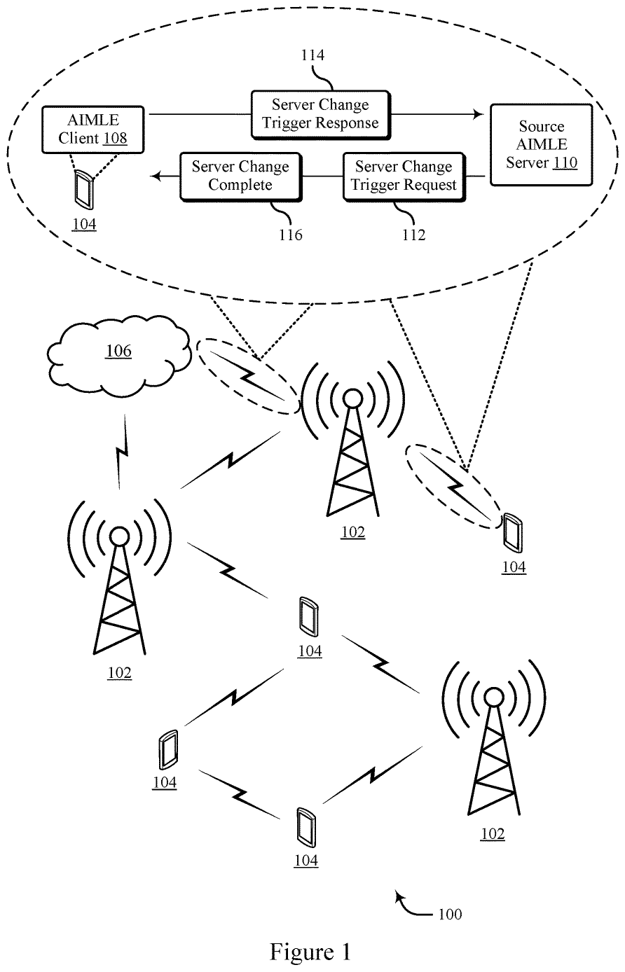

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHZ), FR4 (52.6 GHz-114.25 GHz), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

A PLMN may refer to a network established and operated by a mobile network operator to provide wireless communication services. A UE 104 may be registered with a home PLMN (H-PLMN) and may roam to a visited PLMN (V-PLMN) when the UE 104 moves to a geographic area served by a different mobile network operator. When the UE 104 roams, the UE 104 may connect to network infrastructure of the V-PLMN while maintaining a subscription relationship with the H-PLMN.

The wireless communications system 100 may support a service enabler architecture layer (SEAL) that provides a set of common application-layer services and capabilities for vertical applications. SEAL may define functional entities, interfaces, and APIs that enable vertical applications to access network services. The AIMLE framework may be implemented as part of or in conjunction with SEAL to provide AI/ML capabilities to vertical applications. Within the AIMLE framework, several entities may interact to support AI/ML operations. An AIMLE server may be an application-layer server that provides AI/ML services, such as model training and inference, and may be deployed at an edge computing platform, a cloud infrastructure, or a data center associated with a PLMN operator. An ML repository may be a data store or service that maintains information about available AIMLE servers, AI/ML models, and associated metadata, and may be deployed at a network operator's infrastructure or at a centralized cloud platform accessible by multiple PLMNs. A VAL server may be an application-layer server that manages and coordinates vertical application services for one or more UEs. For example, a VAL server may manage vehicle-to-everything (V2X) communication services, public safety services, or industrial automation services. The VAL server may interact with the AIMLE server to request AI/ML operations on behalf of a VAL application. AIMLE servers, ML repositories, and VAL servers may implement or be implemented by one or more NEs 102.

These entities may communicate using APIs defined within the SEAL framework. An API may refer to a set of protocols, data structures, and operations that define how entities communicate and exchange information. In some cases, an API may define one or more custom operations, which are operations that do not have associated resources (e.g., persistent data objects) managed by the API. Custom operations may use Hypertext Transfer Protocol (HTTP) methods (e.g., HTTP POST) to transmit data structures between entities without creating or modifying persistent resources at the receiving entity. Operations that span across different PLMNs, such as discovering AIMLE servers in a V-PLMN from a source AIMLE server in an H-PLMN, may be referred to herein as cross-PLMN operations.

AI/ML model training may refer to a process of using data to develop or update an AI/ML model, such that the AI/ML model learns to produce outputs based on inputs. AI/ML model inference may refer to a process of applying a trained AI/ML model to input data to produce an output, such as a prediction, classification, or decision. When a UE is performing an AI/ML operation via an AIMLE client, the AI/ML operation may involve ongoing data exchange between the AIMLE client and the AIMLE server. Disruption of this data exchange during roaming may result in loss of training progress, interruption of inference results, or degradation of the VAL application that depends on the AI/ML operation.

To maintain continuity of the AI/ML operation, AIMLE service migration may support different types of service continuity. For example, a first type of service continuity may involve migrating the AIMLE service (e.g., the AI/ML model inference operation) from the source AIMLE server to a target AIMLE server, such that the target AIMLE server assumes responsibility for the AI/ML operation. A second type of service continuity may involve relaying the AIMLE service output from the source AIMLE server to the AIMLE client via the V-PLMN, such that the source AIMLE server continues to perform the ML operation while the output is forwarded through the target AIMLE server. When an AIMLE server change occurs, the VAL server may be notified so that the VAL server can update its records and maintain coordination with the new AIMLE server serving the AIMLE client.

According to implementations, one or more of the NEs 102 and the UEs 104 may be operable to implement various aspects of the techniques described with reference to the present disclosure. The wireless communications system 100 may support an AIMLE framework that includes an AIMLE client 108 and a source AIMLE server 110. The AIMLE client 108 may be associated with one of the UEs 104 and may communicate with the source AIMLE server 110 to perform ML model training and/or inference operations. In some examples, the AIMLE client 108 may be a software component or function operating at the UE 104 that manages ML operations on behalf of a VAL application at the UE 104. When the AIMLE client 108 transmits or receives signaling as described herein, the UE 104 may perform the transmitting or receiving on behalf of the AIMLE client 108. Similarly, when the source AIMLE server 110 transmits or receives signaling, the NE 102 implementing the source AIMLE server 110 may perform the transmitting or receiving on behalf of the source AIMLE server 110.

The AIMLE client 108 may detect or predict mobility of the UE 104 to an area covered by a different PLMN. For example, the AIMLE client 108 or the source AIMLE server 110 may subscribe to receive location reporting from a location management service or location analytics from an application data analytics enablement service. Based on the location information, the AIMLE client 108 may determine that the UE 104 is expected to move to an area served by a V-PLMN and may transmit an indication of the mobility to the source AIMLE server 110. The source AIMLE server 110 may identify the V-PLMN based on the mobility indication and may initiate a service migration procedure to maintain continuity of the ML operation. For example, the source AIMLE server 110 may transmit, to an ML repository via a custom server discovery request operation, a cross-PLMN AIMLE server discovery request indicating one or more parameters representative of criteria for AIMLE server discovery. The one or more parameters may indicate attributes associated with AIMLE servers such as a geographical area, server capability, load and energy efficiency, or server ranking. The ML repository may store pre-configured information about AIMLE servers available in different PLMNs. The ML repository may respond with a server discovery response that includes a first list of AIMLE servers in the V-PLMN that match the one or more parameters.

The source AIMLE server 110 may transmit, to the AIMLE client 108 via a custom server change trigger operation, a server change trigger request 112 including the first list of AIMLE servers. The server change trigger request 112 may also include context information associated with the first list of AIMLE servers. The context information may describe attributes of the individual AIMLE servers in the first list, such as server capability, coverage area, load and energy status, or server ranking, and is provided to the AIMLE client 108 to enable the AIMLE client 108 to evaluate and down-select from the first list. While the context information may include attributes similar to the one or more parameters used for server discovery, the context information is provided to the AIMLE client 108 for server selection, whereas the one or more parameters are provided to the ML repository for server discovery.

The AIMLE client 108 may respond with a server change trigger response 114 indicating a second list of AIMLE servers comprising a subset of the first list of AIMLE servers. For example, the AIMLE client 108 may down-select from the first list based on the context information and may indicate one or more preferred AIMLE servers in the server change trigger response 114.

The source AIMLE server 110 may then select a target AIMLE server from the second list of AIMLE servers indicated in the server change trigger response 114 and may transmit, to the AIMLE client 108 via a custom server change complete operation, a server change complete 116 message indicating the target AIMLE server. Upon receiving the server change complete 116 message, the AIMLE client 108 may connect to the target AIMLE server in the V-PLMN for continuity of the ML operation. The source AIMLE server 110 may also transmit the server change complete 116 message to the target AIMLE server and a VAL server to notify them of the migration. In some examples, the type of service continuity (e.g., relay or migration) may be indicated in the server change trigger request 112 and/or the server change complete 116 message.

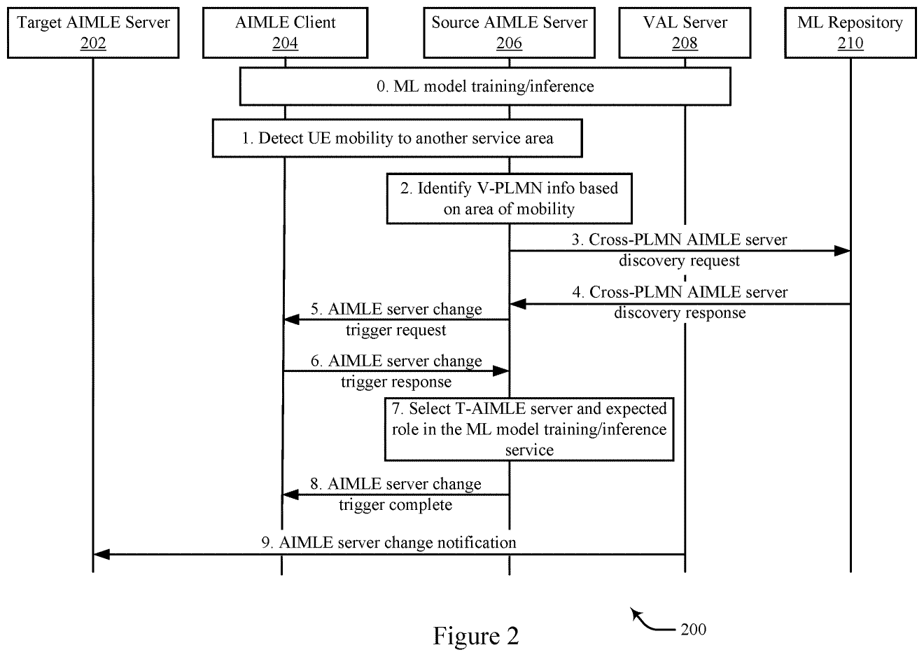

FIG. 2 illustrates a signaling diagram 200 in accordance with aspects of the present disclosure. In some examples, the signaling diagram 200 implements or is implemented by aspects of the wireless communications system 100. The signaling diagram 200 includes a target AIMLE server 202, an AIMLE client 204, a source AIMLE server 206, a VAL server 208, and an ML repository 210, which may be examples of corresponding entities as described with reference to FIG. 1. For example, the target AIMLE server 202, the source AIMLE server 206, the VAL server 208, and the ML repository 210 may implement or be implemented by one or more NEs 102. The AIMLE client 204 may implement or be implemented by a UE 104. Alternative examples of the following may be implemented, where some processes are performed in a different order than described or are not performed. In some cases, processes may include additional features not mentioned below, or further processes may be added.

The signaling diagram 200 illustrates an AIMLE service migration procedure that utilizes two APIs and three custom operations. A first API (e.g., an MLR_ServiceMigration API) may be used for interactions between the source AIMLE server 206 and the ML repository 210. A second API (e.g., an AIMLES_ServiceMigration API) may be used for interactions between the source AIMLE server 206 and the AIMLE client 204, as well as between the source AIMLE server 206 and the target AIMLE server 202 and the VAL server 208. The three custom operations include a custom server discovery request operation using the first API, a custom server change trigger operation using the second API, and a custom server change complete operation using the second API. The custom operations are implemented without associated resources, using HTTP POST methods to transmit data structures between entities.

At step 0, the AIMLE client 204 is performing an ML model training and/or inference operation based on a VAL request. For example, the AIMLE client 204 may be connected to the source AIMLE server 206 via an H-PLMN and may be exchanging data with the source AIMLE server 206 as part of an ongoing ML operation.

At step 1, the AIMLE client 204 detects an expected or predicted mobility of a UE to an area covered by a different PLMN. For example, the AIMLE client 204 or the source AIMLE server 206 may have subscribed to receive location reporting from a location management service or location analytics from an application data analytics enablement service. Based on the location information, the AIMLE client 204 may determine that the UE is expected to move to an area served by a V-PLMN. The AIMLE client 204 may optionally transmit a mobility report to the source AIMLE server 206 indicating a cross-PLMN mobility event notification for the UE.

At step 2, the source AIMLE server 206 identifies the V-PLMN information and the time when the UE is expected to reach the V-PLMN. The source AIMLE server 206 may use the mobility report from the AIMLE client 204 or may independently determine the V-PLMN information based on location analytics.

At step 3, the source AIMLE server 206 transmits a cross-PLMN AIMLE server discovery request to the ML repository 210 to fetch the available AIMLE servers in the target V-PLMN for the AIMLE client 204 associated with the UE moving to the V-PLMN. The cross-PLMN AIMLE server discovery request is transmitted via the first API (e.g., the MLR_ServiceMigration API) as part of the server discovery request operation. The server discovery request operation is a custom operation without associated resources, using an HTTP POST method with a request uniform resource identifier (URI) targeting a request endpoint (e.g., /request). A URI may refer to a string of characters that identifies a particular resource or endpoint on a network, such as an API endpoint or a custom operation endpoint. The request body may include a server discovery request data structure (e.g., SvrDscReq) containing a requester identifier identifying the source AIMLE server 206 and discovery criteria for finding AIMLE servers in the V-PLMN.

The discovery criteria may include or be an example of one or more parameters describing requirements or preferences for a target AIMLE server based on the needs of the ongoing AI/ML operation and the AIMLE client 204. For example, the one or more parameters may indicate attributes of the AIMLE servers to be discovered, such as server capabilities (e.g., computational capability, processing capability), coverage area (e.g., a geographical or topological area covered by the target AIMLE server), load and energy efficiency (e.g., load consumption and efficiency, energy consumption and efficiency), and server ranking (e.g., a rate, ranking, or weighting based on fulfilment of previous tasks and statistics, with a minimum value of 0 indicating worst ranking and a maximum value of 100 indicating best ranking). The server ranking may be an integer value. In some cases, at least one of the discovery criteria is present in the request. The one or more parameters may be represented by a data structure that contains one or more sub-elements, such that the data structure may include a single parameter (e.g., only server capability) or multiple parameters (e.g., server capability and server ranking).

At step 4, the source AIMLE server 206 receives, from the ML repository 210 as part of the server discovery request operation, a cross-PLMN AIMLE server discovery response with a list of the available (i.e., candidate) AIMLE servers in the target V-PLMN, e.g., based on the discovery criteria. The server discovery response may include a server discovery response data structure (e.g., SvrDscResp) containing the list of AIMLE servers that match the discovery criteria and, optionally, AIMLE-supported task information. The AIMLE-supported task information may include a list of AIMLE task providers, key performance indicators for the AIMLE task performance, and a required availability duration of the AIMLE task service. Upon successful processing, the ML repository 210 may respond with an HTTP 200 OK status code with the response body containing the server discovery response data structure. If the request fails, the ML repository 210 may respond with an appropriate HTTP error status code in the 4xx or 5xx range. The ML repository 210 may also respond with an HTTP 307 Temporary Redirect or 308 Permanent Redirect status code including a Location header containing an alternative URI of an alternative ML repository. It is assumed that the available AIMLE servers for the V-PLMN are pre-configured at the ML repository 210.

At step 5, the source AIMLE server 206 transmits an AIMLE server change trigger request to the AIMLE client 204 for notifying the AIMLE client 204 of the available AIMLE servers. The server change trigger request indicates the list of AIMLE servers received from the ML repository 210. The server change trigger request is transmitted via the second API (e.g., the AIMLES_ServiceMigration API) as part of the server change trigger operation. The server change trigger operation is a custom operation without associated resources, using an HTTP POST method with a request URI targeting a trigger endpoint (e.g., /trigger). The request body may include a server change trigger data structure (e.g., AimleServerChangeTriggerReq) containing an AIMLE service identifier identifying the AIMLE service for which the AIMLE server change is triggered, UE identifiers identifying the UEs for which the AIMLE server change is triggered, the list of AIMLE server identifiers and, in some cases, associated discovery criteria (i.e., the one or more parameters), a roaming PLMN identifier identifying the V-PLMN, and an indication of a type of AIMLE service continuity (e.g., whether the service continuity is based on migration or relaying). The server change trigger request may also include context information associated with the available AIMLE servers, such as rating or ranking information, capability information, or energy and load status.

At step 6, the AIMLE client 204, based on the received list, optionally down-selects the target AIMLE server from the list of AIMLE servers based on the fetched information, and provides an AIMLE server change trigger response to the source AIMLE server 206 as part of the server change trigger operation. For example, the AIMLE client 204 may select one or more AIMLE servers from the list based on the context information, such as capabilities, expected delay or latency, cost for task migration, or rate and ranking. The server change trigger response may include a server change trigger response data structure (e.g., AimleServerChangeTriggerResp) containing selected AIMLE server identifiers representing the AIMLE client's selection from the candidate servers. The selected AIMLE server identifiers may represent a second list of AIMLE servers that comprises a subset of the first list of AIMLE servers provided in the server change trigger request. Upon successful processing, the AIMLE client 204 may respond with an HTTP 200 OK status code with the response body containing the server change trigger response data structure. If the AIMLE server is not authorized or the request is not handled successfully, the AIMLE client 204 may respond with an appropriate HTTP error status code in the 4xx or 5xx range. The AIMLE client 204 may also respond with an HTTP 307 Temporary Redirect or 308 Permanent Redirect status code including a Location header containing an alternative URI of an alternative AIMLE client.

At step 7, the source AIMLE server 206 determines the target AIMLE server (e.g., the target AIMLE server 202) to be selected for the ML model training and/or inference service continuity at the target V-PLMN for the AIMLE client 204, based on the selection criteria provided by the AIMLE client 204 in step 6. The source AIMLE server 206 may select the target AIMLE server from the second list of AIMLE servers (e.g., the subset indicated in the server change trigger response) based on the context information associated with the available AIMLE servers. The server change complete message transmitted at step 8 may indicate the target AIMLE server selected from the second list of AIMLE servers.

At step 8, the source AIMLE server 206 transmits an AIMLE server change complete message to the AIMLE client 204, indicating the target AIMLE server information and possible limitations in the target V-PLMN (e.g., lower priority, capacity limitations for ML operations). The server change complete message is transmitted via the second API (e.g., the AIMLES_ServiceMigration API) as part of the server change complete operation. The server change complete operation is a custom operation without associated resources, using an HTTP POST method with a request URI targeting a complete endpoint (e.g., /complete). The request body may include a server change complete data structure (e.g., AimleServerChangeComplete) containing an AIMLE client identifier identifying the AIMLE client that completes the AIMLE server change, UE identifiers identifying the UEs for which the AIMLE server change is to be completed, an AIMLE service identifier identifying the AIMLE service for which the AIMLE server is changed, a roaming PLMN identifier identifying the V-PLMN, and a type of AIMLE service continuity indicating whether the service continuity is based on migration or relaying. Upon successful processing, the AIMLE client 204 may respond with an HTTP 204 No Content status code. If the AIMLE server is not authorized or the request is not handled successfully, the AIMLE client 204 may respond with an appropriate HTTP error status code in the 4xx or 5xx range. The AIMLE client 204 may also respond with an HTTP 307 Temporary Redirect or 308 Permanent Redirect status code including a Location header containing an alternative URI of an alternative AIMLE client. Following receipt of the server change complete message, the AIMLE client 204 confirms and connects to the target AIMLE server 202 via the source AIMLE server 206. Based on successful AIMLE server migration, an AIMLE context transfer procedure may follow.

At step 9, the source AIMLE server 206 transmits an AIMLE server change notification to the target AIMLE server 202 and the VAL server 208, informing them of the expected change of the AIMLE server from source to target in the V-PLMN. The AIMLE server change notification reuses the same server change complete operation and the same server change complete data structure (e.g., AimleServerChangeComplete) as used in step 8. The server change complete operation is transmitted via the second API (e.g., the AIMLES_ServiceMigration API) to the target AIMLE server 202 and the VAL server 208. Upon successful processing, the target AIMLE server 202 and the VAL server 208 may each respond with an HTTP 204 No Content status code. If the request fails, the target AIMLE server 202 and/or the VAL server 208 may respond with an appropriate HTTP error status code in the 4xx or 5xx range.

The first API (e.g., the MLR_ServiceMigration API) may have an API name of “mlr-smig” and a version of “v1.” The API URI of the first API may be structured as {apiRoot}/mlr-smig/v1/<apiSpecificSuffixes>, where the apiSpecificSuffixes correspond to the custom operation URI (e.g., /request for the server discovery request operation). The second API (e.g., the AIMLES_ServiceMigration API) may have an API name of “aimlec-smig” and a version of “v1.” The API URI of the second API may be structured as {apiRoot}/aimlec-smig/v1/<apiSpecificSuffixes>, where the apiSpecificSuffixes correspond to the custom operation URIs (e.g., /trigger for the server change trigger operation, /complete for the server change complete operation).

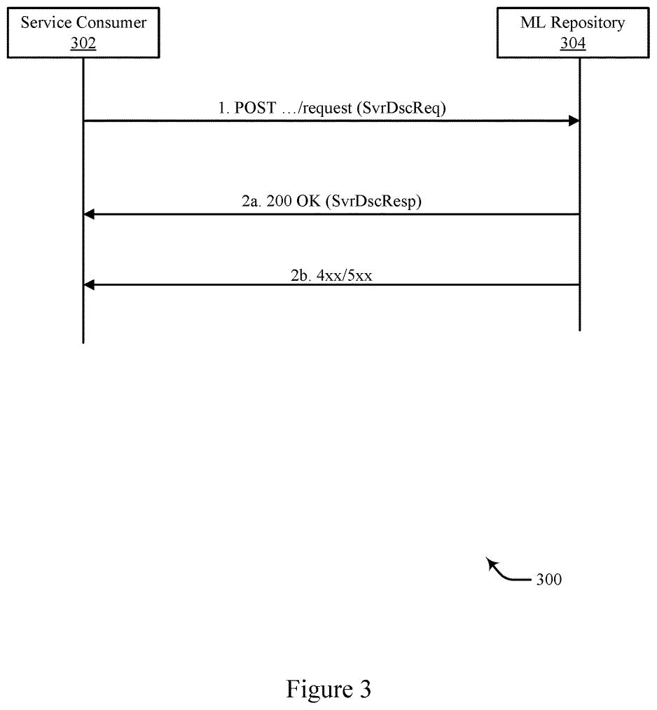

FIG. 3 illustrates a signaling diagram 300 in accordance with aspects of the present disclosure. In some examples, the signaling diagram 300 implements or is implemented by aspects of the wireless communications system 100 and the signaling diagram 200. The signaling diagram 300 includes a service consumer 302 and an ML repository 304, which may be examples of the source AIMLE server 206 and the ML repository 210, respectively, as described with reference to FIG. 2. service consumer 302 and the ML repository 304 may implement or be implemented by one or more NEs 102. Alternative examples of the following may be implemented, where some processes are performed in a different order than described or are not performed. In some cases, processes may include additional features not mentioned below, or further processes may be added.

The signaling diagram 300 depicts the interactions between the service consumer 302 and the ML repository 304 for cross-PLMN AIMLE server discovery. The cross-PLMN AIMLE server discovery is performed using the first API (e.g., the MLR_ServiceMigration API) described with reference to FIG. 2. The MLR_ServiceMigration API is exposed by the ML repository 304 and enables the service consumer 302 to request discovery of a cross-PLMN AIMLE server. The MLR_ServiceMigration API defines a server discovery request operation (e.g., MLR_AIMLEServerDiscovery_Request) that is a custom operation without associated resources, initiated by the service consumer 302. The API URI of the MLR_ServiceMigration API may be structured as {apiRoot}/mlr-smig/v1/<apiSpecificSuffixes>, where the apiSpecificSuffixes correspond to the custom operation URI.

The MLR_ServiceMigration API defines the following data types:

| Data type | Description |
|---|---|
| SvrDscReq | Represents the cross-PLMN AIMLE server |
| | discovery request |
| SvrDscResp | Represents the cross-PLMN AIMLE server |
| | discovery response |
| AimleSvrDsc | Identifies criteria for discovery of a cross- |
| | PLMN AIMLE server |
| AimlSvr | Identifies an AIMLE server that matches the |
| | criteria for discovery of a cross-PLMN AIMLE |
| | server |
| AimlTaskInfo | Identifies AIMLE-supported task information |
| SvrCapability | Identifies the AIMLE server capabilities |
| LoadEnergyEff | Identifies load and energy efficiency of the |
| | AIMLE server to be discovered |

The MLR_ServiceMigration API may also reuse data types from other specifications, such as a geographic area data type (e.g., GeographicArea) for identifying geographical information, a service performance KPI data type (e.g., ServPerfKpi) for identifying key performance indicators for the AIMLE service performance, and a time window data type (e.g., TimeWindow) for identifying a time window.

The MLR_ServiceMigration API defines the following custom operation without associated resources:

| Custom | Custom | Mapped HTTP | |
|---|---|---|---|
| operation name | operation URI | method | Description |
| RequestSvrDsc | /request | POST | Request discovery of |
| | | | a cross-PLMN |
| | | | AIMLE server |

The server discovery request operation supports the following request and response data structures:

| Data type | Optionality | Description |
|---|---|---|
| SvrDscReq | Mandatory | Contains the parameters to |
| (request body) | | request cross-PLMN AIMLE |
| | | server discovery |
| Data type | Response code | Description |
| SvrDscResp | 200 OK | The cross-PLMN AIMLE |
| (response body) | | server discovery request is |
| | | successfully received and |
| | | processed |
| n/a | 307 Temporary | Temporary redirection to an |
| | Redirect | alternative ML repository |
| n/a | 308 Permanent | Permanent redirection to an |
| | Redirect | alternative ML repository |

In step 1, the service consumer 302 transmits an HTTP POST request to the ML repository 304 targeting the URI of the server discovery request operation (e.g., {apiRoot}/mlr-smig/v1/request). The request body includes a server discovery request data structure (e.g., SvrDscReq). The server discovery request data structure contains a requester identifier (e.g., requesterId) that identifies the service consumer 302 (e.g., the source AIMLE server), and discovery criteria (e.g., AimleSvrDsc) for finding AIMLE servers in the visited PLMN. The discovery criteria may be represented by a discovery criteria data structure (e.g., AimleSvrDsc) that includes a server identifier (e.g., svrId) identifying the AIMLE server, a server capability attribute (e.g., svrCap) identifying the capabilities of the AIMLE server to be discovered, a server coverage area attribute (e.g., svrCoverArea) identifying the geographical area covered by the AIMLE server to be discovered, a load and energy efficiency attribute (e.g., svrLoadEnergy) identifying the load and energy efficiency of the AIMLE server to be discovered, and a server ranking attribute (e.g., svrRank) identifying the rank of the AIMLE server to be discovered. The server ranking attribute may be an integer value with a minimum value (e.g., 0) indicating worst ranking and a maximum value (e.g., 100) indicating best ranking. At least one of the server capability attribute, the server coverage area attribute, the load and energy efficiency attribute, or the server ranking attribute may be present in the discovery criteria.

The server discovery request data structure (e.g., SvrDscReq) may include the following attributes:

| Attribute name | Data type | Optionality | Description |
|---|---|---|---|
| requesterId | string | Mandatory | Identifier of the |
| | | | service consumer |
| | | | (e.g., AIMLE server) |
| aimleSvrDsc | AimleSvrDsc | Mandatory | Identifies criteria for |
| | | | discovery of a cross- |
| | | | PLMN AIMLE server |

The discovery criteria data structure (e.g., AimleSvrDsc) may include the following attributes:

| Attribute name | Data type | Optionality | Description |
|---|---|---|---|
| svrId | string | Mandatory | Identifies the AIMLE |
| | | | server |
| svrCap | SvrCapability | Conditional | Identifies the AIMLE |
| | | | server capabilities |
| svrCoverArea | GeographicArea | Conditional | Identifies |
| | | | geographical area |
| | | | covered by the |
| | | | AIMLE server to be |
| | | | discovered |
| svrLoadEnergy | LoadEnergyEff | Conditional | Identifies load and |
| | | | energy efficiency of |
| | | | the AIMLE server to |
| | | | be discovered |
| svrRank | integer (0-100) | Conditional | Identifies the rank of |
| | | | the AIMLE server to |
| | | | be discovered |

The server capability attribute may indicate one or more of computational capabilities or processing capabilities of the AIMLE server, and may be represented by an enumeration (e.g., SvrCapability) with values indicating computational capabilities (e.g., COMPUTATIONAL) or processing capabilities (e.g., PROCESSING). The load and energy efficiency attribute may indicate one or more of load consumption and efficiency or energy consumption and efficiency of the AIMLE server, and may be represented by an enumeration (e.g., LoadEnergyEff) with values indicating load efficiency (e.g., LOAD_EFFICIENCY) or energy efficiency (e.g., ENERGY_EFFICIENCY). The server coverage area attribute may indicate a geographical or topological area covered by the AIMLE server, and may be represented using a geographic area data structure (e.g., GeographicArea).

In step 2a, upon successful processing of the request, the ML repository 304 responds to the service consumer 302 with an HTTP 200 OK status code. The response body contains a server discovery response data structure (e.g., SvrDscResp). The server discovery response data structure includes a list of AIMLE servers (e.g., svrList) that match the discovery criteria. Each AIMLE server entry in the list may be represented by an AIMLE server data structure (e.g., AimlSvr) that includes a PLMN identifier (e.g., plmnID) identifying the PLMN where the AIMLE client is roaming and/or an AIMLE client identifier (e.g., aimleClient) identifying the AIMLE client that is roaming. At least one of the PLMN identifier or the AIMLE client identifier may be present in each AIMLE server entry. The server discovery response data structure may also include AIMLE-supported task information (e.g., aimlSuppTask) represented by a task information data structure (e.g., AimlTaskInfo). The task information data structure may include a list of AIMLE task providers (e.g., providerList), key performance indicators for the AIMLE task performance (e.g., servPerfKpi), and a required availability duration of the AIMLE task service (e.g., taskAvailability) represented by a time window.

The server discovery response data structure (e.g., SvrDscResp) may include the following attributes:

| Attribute name | Data type | Optionality | Description |
|---|---|---|---|
| svrList | array(AimlSvr) | Mandatory | Identifies list of |
| | | | AIMLE servers that |
| | | | match the criteria for |
| | | | discovery of a cross- |
| | | | PLMN AIMLE server |
| aimlSuppTask | AimlTaskInfo | Optional | Identifies AIMLE- |
| | | | supported task |
| | | | information |

Each AIMLE server entry (e.g., AimlSvr) may include the following attributes:

| Attribute name | Data type | Optionality | Description |
|---|---|---|---|
| plmnID | string | Conditional | Identifies the PLMN |
| | | | where the AIMLE |
| | | | client is roaming |
| aimleClient | string | Conditional | Identifies the AIMLE |
| | | | client that is roaming |

The task information data structure (e.g., AimlTaskInfo) may include the following attributes:

| Attribute name | Data type | Optionality | Description |
|---|---|---|---|
| providerList | array(string) | Mandatory | Identifies the list of |
| | | | AIMLE task |
| | | | providers |
| servPerfKpi | ServPerfKpi | Mandatory | Identifies the key |
| | | | performance |
| | | | indicators for the |
| | | | AIMLE task |
| | | | performance |
| taskAvailability | TimeWindow | Mandatory | Identifies the required |
| | | | availability duration |
| | | | of the AIMLE task |
| | | | service |

Alternatively, if the request fails, the ML repository 304 responds in step 2b with an appropriate HTTP error status code in the 4xx or 5xx range. The 4xx status codes indicate client errors, while the 5xx status codes indicate server errors. Additionally, or alternatively, the ML repository 304 may respond with an HTTP 307 Temporary Redirect status code or an HTTP 308 Permanent Redirect status code including a Location header containing an alternative URI of an alternative ML repository towards which the request may be redirected.

For the MLR_ServiceMigration API, HTTP error responses may be supported in accordance with applicable error handling provisions. In some cases, the ML repository 304 may return additional error information in the HTTP POST response body. The MLR_ServiceMigration API may support feature negotiation using an extensibility mechanism, and security provisions may apply to the MLR_ServiceMigration API.

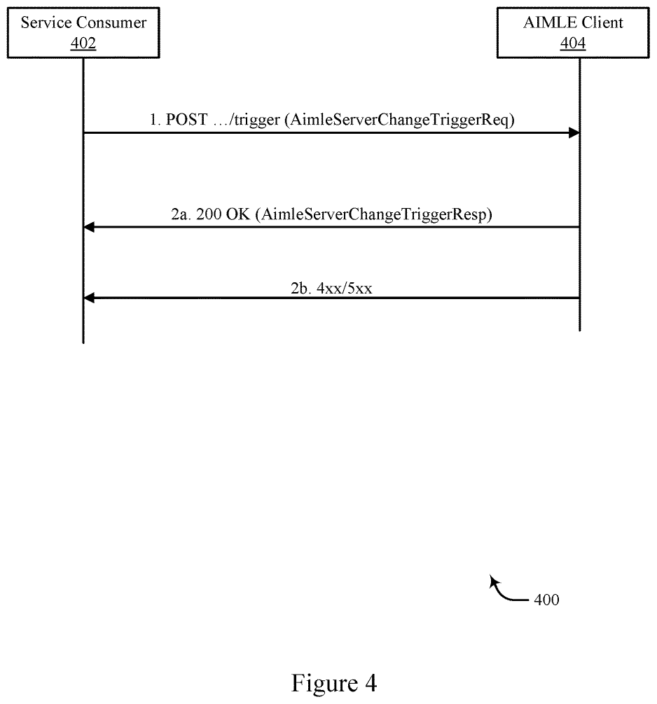

FIG. 4 illustrates a signaling diagram 400 in accordance with aspects of the present disclosure. In some examples, the signaling diagram 400 implements or is implemented by aspects of the wireless communications system 100 and the signaling diagram 200. The signaling diagram 400 includes a service consumer 402 and an AIMLE client 404, which may be examples of the source AIMLE server 206 and the AIMLE client 204, respectively, as described with reference to FIG. 2. The service consumer 402 may implement or be implemented by one or more NEs 102, while the AIMLE client 404 may implement or be implemented by a UE 104. Alternative examples of the following may be implemented, where some processes are performed in a different order than described or are not performed. In some cases, processes may include additional features not mentioned below, or further processes may be added.

The signaling diagram 400 depicts the interactions between the service consumer 402 and the AIMLE client 404 during a server change trigger operation. The server change trigger operation is performed using the second API (e.g., the AIMLES_ServiceMigration API) described with reference to FIG. 2. The AIMLES_ServiceMigration API enables the AIMLE server to trigger and complete an AIMLE server change. The AIMLES_ServiceMigration API defines a server change trigger operation (e.g., Aimles_ServerChange_Trigger) and a server change complete operation (e.g., Aimles_ServerChange_Complete), both of which are custom operations without associated resources initiated by the AIMLE server (e.g., the service consumer 402). The API URI of the AIMLES_ServiceMigration API may be structured as {apiRoot}/aimlec-smig/v1/<apiSpecificSuffixes>, where the apiSpecificSuffixes correspond to the custom operation URIs.

The AIMLES_ServiceMigration API defines the following data types:

| Data type | Description |
|---|---|
| AimleServerChangeTriggerReq | Identifies information for AIMLE server |
| | change trigger |
| AimleServerChangeTriggerResp | Identifies information in the response to |
| | AIMLE server change trigger |
| AimleServerChangeComplete | Identifies information for AIMLE server |
| | change complete |
| AimleSrvContType | Identifies type of the AIMLE service |
| | continuity |

The AIMLES_ServiceMigration API may also reuse data types from other specifications, such as a discovery criteria data type (e.g., AimleSvrDsc) for identifying criteria for discovery of a cross-PLMN AIMLE server as described with reference to FIG. 3, a PLMN identifier data type (e.g., PlmnIdNid) for representing the identifier of a PLMN, and a VAL target UE data type (e.g., ValTargetUe) for uniquely identifying a VAL user or a VAL UE.

The AIMLES_ServiceMigration API defines the following custom operations without associated resources:

| | Custom | Mapped | |
|---|---|---|---|
| Operation | operation | HTTP | |
| name | URI | method | Description |
| AIMLE server | /trigger | POST | Used by the AIMLE |
| change trigger | | | server to trigger the |
| | | | AIMLE server |
| | | | change |
| AIMLE server | /complete | POST | Used by the AIMLE |
| change complete | | | server to complete the |
| | | | AIMLE server |
| | | | change |

The server change trigger operation supports the following request and response data structures:

| | Option- | |
|---|---|---|
| Data type | ality | Description |
| AimleServerChangeTrig- | Mandatory | Information provided to the |
| gerReq (request body) | | AIMLE client for triggering |
| | | the AIMLE server change |
| | Response | |
| Data type | code | Description |
| AimleServerChangeTrig- | 200 OK | The AIMLE server change |
| gerResp (response body) | | trigger information is |
| | | successfully received, |
| | | processed, and provisioned |
| n/a | 307 | Temporary redirection to an |
| | Temporary | alternative AIMLE client |
| | Redirect | |
| n/a | 308 | Permanent redirection to an |
| | Permanent | alternative AIMLE client |
| | Redirect | |

The server change complete operation supports the following request and response data structures:

| | Option- | |
|---|---|---|
| Data type | ality | Description |
| AimleServerChangeCom- | Mandatory | Information provided to the |
| plete (request body) | | AIMLE client for completing |
| | | the AIMLE server change |
| | Response | |
| Data type | code | Description |
| n/a | 204 No | The AIMLE server change |
| | Content | complete information is |
| | | successfully received, |
| | | processed, and provisioned |
| n/a | 307 | Temporary redirection to an |
| | Temporary | alternative AIMLE client |
| | Redirect | |
| n/a | 308 | Permanent redirection to an |
| | Permanent | alternative AIMLE client |
| | Redirect | |

The service continuity type enumeration (e.g., AimleSrvContType) may include the following values:

| Enumeration value | Description |
|---|---|
| MIGRATION | AIMLE service continuity is based on |
| | migration |
| RELAYING | AIMLE service continuity is based on relaying |

In step 1, the service consumer 402 transmits an HTTP POST request to the AIMLE client 404 targeting the URI of the server change trigger operation (e.g., {apiRoot}/aimlec-smig/v1/trigger). The request body includes a server change trigger request data structure (e.g., AimleServerChangeTriggerReq). The server change trigger request data structure contains an AIMLE service identifier (e.g., aimleServiceId) that identifies the AIMLE service for which the AIMLE server change is triggered. The AIMLE service identifier is a mandatory attribute. The server change trigger request data structure also contains UE identifiers (e.g., valUeIds) that identify the UEs for which the AIMLE server change is triggered. The UE identifiers are optional and may be represented as an array of VAL target UE identifiers.

The server change trigger request data structure further contains a list of candidate AIMLE server identifiers (e.g., aimleServerIds) that identifies candidate AIMLE servers for the server change, e.g., the list of AIMLE servers returned by the ML repository 304 as described with reference to FIG. 3. The candidate AIMLE server identifiers are mandatory and may be represented as an array of discovery criteria data structures (e.g., AimleSvrDsc), where each entry includes server capability, coverage area, load and energy efficiency, and server ranking information as described with reference to FIG. 3. The server change trigger request data structure also contains a roaming PLMN identifier (e.g., plmnId) that identifies the visited PLMN. The roaming PLMN identifier is optional and may be represented by a PLMN identifier data structure (e.g., PlmnIdNid). The server change trigger request data structure further contains a type of AIMLE service continuity (e.g., aimleSrvMig) that identifies the type of service continuity for the migration. The type of AIMLE service continuity is a mandatory attribute and may be represented by a service continuity type enumeration (e.g., AimleSrvContType) with values indicating migration (e.g., MIGRATION), in which the AIMLE service is migrated to the target AIMLE server, or relaying (e.g., RELAYING), in which the AIMLE service output is relayed to the consumer via the visited PLMN.

The server change trigger request data structure (e.g., AimleServerChangeTriggerReq) may include the following attributes:

| Attribute | | Option- | |
|---|---|---|---|
| name | Data type | ality | Description |
| aimleServiceId | string | Mandatory | Identifies the AIMLE |
| | | | service for which the |
| | | | AIMLE server |
| | | | change is triggered |
| valUeIds | array(ValTargetUe) | Optional | Identifies the UE IDs |
| | | | for which the AIMLE |
| | | | server change is |
| | | | triggered |
| aimleServerIds | array(AimleSvrDsc) | Mandatory | Identifies list of |
| | | | candidate AIMLE |
| | | | servers |
| plmnId | PlmnIdNid | Optional | Identifies the roaming |
| | | | PLMN |
| aimleSrvMig | AimleSrvContType | Mandatory | Identifies type of the |
| | | | AIMLE service |
| | | | continuity |

In step 2a, upon receipt of the HTTP POST request, the AIMLE client 404 verifies the identity of the service consumer 402 and determines if the service consumer 402 is authorized for the request. If the service consumer 402 is authorized and the HTTP POST request is handled successfully, the AIMLE client 404 responds to the service consumer 402 with an HTTP 200 OK status code. The response body contains a server change trigger response data structure (e.g., AimleServerChangeTriggerResp). The server change trigger response data structure contains selected AIMLE server identifiers (e.g., selAimleServerIds) represented as an optional array of strings. The selected AIMLE server identifiers identify the AIMLE servers selected by the AIMLE client 404 from the list of candidate AIMLE servers provided in the request. The AIMLE client 404 may down-select from the list of candidate AIMLE servers based on the context information provided in the request, such as capabilities, expected delay or latency, cost for task migration, or rate and ranking.

The server change trigger response data structure (e.g., AimleServerChangeTriggerResp) may include the following attributes:

| Attribute name | Data type | Optionality | Description |
|---|---|---|---|
| selAimleServerIds | array(string) | Optional | Identifies the selected |
| | | | AIMLE servers in |
| | | | roaming network by |
| | | | the AIMLE client |

Alternatively, in step 2b, if the service consumer 402 is not authorized to request or if the HTTP POST request is not handled successfully, the AIMLE client 404 responds with an appropriate HTTP error status code in the 4xx or 5xx range. The AIMLE client 404 may also respond with an HTTP 307 Temporary Redirect status code or an HTTP 308 Permanent Redirect status code including a Location header containing an alternative URI of an alternative AIMLE client towards which the request may be redirected.

The signaling diagram 400 illustrates the server change trigger operation as a custom API operation without associated resources. The operation enables the service consumer 402 to notify the AIMLE client 404 of available AIMLE servers in a visited PLMN and to receive a response indicating which AIMLE servers the AIMLE client 404 has selected from the provided list. This interaction supports AIMLE service migration when a UE associated with the AIMLE client 404 roams to a visited PLMN.

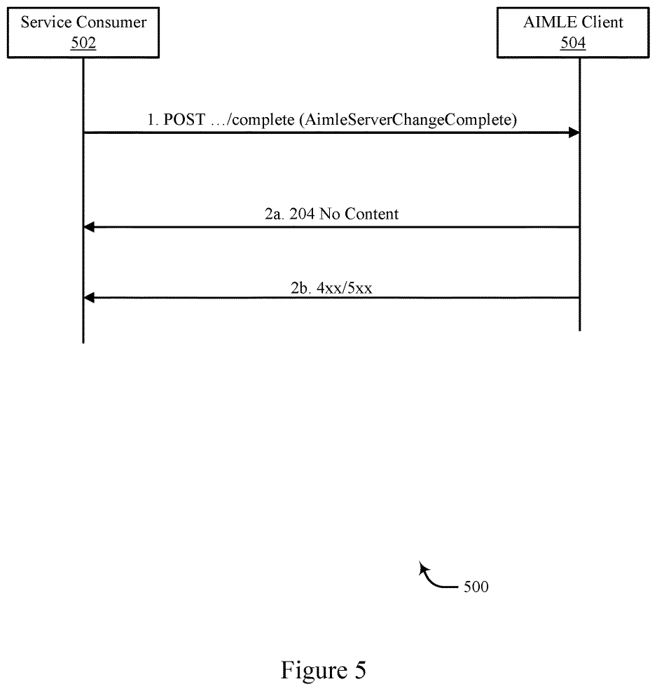

FIG. 5 illustrates a signaling diagram 500 representing a procedure for AIMLE server change complete in accordance with aspects of the present disclosure. In some examples, the signaling diagram 500 implements or is implemented by aspects of the wireless communications system 100 and the signaling diagram 200. The signaling diagram 500 includes a service consumer 502 and an AIMLE client 504, which may be examples of the source AIMLE server 206 and the AIMLE client 204 as described with reference to FIG. 2. The service consumer 502 may implement or be implemented by one or more NEs 102. The AIMLE client 504 may implement or be implemented by a UE 104. Alternative examples of the following may be implemented, where some processes are performed in a different order than described or are not performed. In some cases, processes may include additional features not mentioned below, or further processes may be added.

The signaling diagram 500 depicts the interactions between the service consumer 502 and the AIMLE client 504 during the completion phase of an AIMLE server change operation. The server change complete operation is performed using the second API (e.g., the AIMLES\_ServiceMigration API) described with reference to FIGS. 2 and 4. The server change complete operation (e.g., Aimles\_ServerChange\_Complete) is a custom operation without associated resources, using an HTTP POST method with a request URI targeting a complete endpoint (e.g., {apiRoot}/aimlec-smig/v1/complete).

In step 1, the service consumer 502 transmits an HTTP POST request to the AIMLE client 504 targeting the URI of the server change complete operation (e.g., {apiRoot}/aimlec-smig/v1/complete). The request body includes a server change complete data structure (e.g., AimleServerChangeComplete). The server change complete data structure contains an AIMLE client identifier (e.g., aimleClientId) that identifies the AIMLE client that completes the AIMLE server change. The AIMLE client identifier is a mandatory attribute. The server change complete data structure also contains UE identifiers (e.g., valUeIds) that identify the UEs for which the AIMLE server change is to be completed. The UE identifiers are optional and may include an array of UE identifier data structures (e.g., ValTargetUe). In some cases, at least one of the AIMLE client identifier or the UE identifiers may be present.

The server change complete data structure further contains a target AIMLE server identifier (e.g., tAimleServerId) that identifies the AIMLE server that will be the target AIMLE server. The target AIMLE server identifier is a mandatory attribute. The server change complete data structure further contains an AIMLE service identifier (e.g., aimleServiceId) that identifies the AIMLE service for which the AIMLE server is changed. The AIMLE service identifier is optional. The server change complete data structure also contains a roaming PLMN identifier (e.g., plmnId) that identifies the visited PLMN. The roaming PLMN identifier is optional and may be represented by a PLMN identifier data structure (e.g., PlmnIdNid). The server change complete data structure further contains a type of AIMLE service continuity (e.g., aimleSrvMig) that identifies the type of service continuity for the migration. The type of AIMLE service continuity is a mandatory attribute and may be represented by a service continuity type enumeration (e.g., AimleSrvContType). The service continuity type enumeration may include a value indicating migration (e.g., MIGRATION), in which the AIMLE service (e.g., the ML model inference operation) is migrated to the target AIMLE server, or a value indicating relaying (e.g., RELAYING), in which the AIMLE service output is relayed to the consumer via the visited PLMN.

The server change complete data structure (e.g., AimleServerChangeComplete) may include the following attributes:

| Attribute | | Option- | |
|---|---|---|---|
| name | Data type | ality | Description |
| aimleClientId | ValTargetUe | Mandatory | Identifies the AIMLE |
| | | | client that completes |
| | | | the AIMLE server |
| | | | change |
| valUeIds | array(ValTargetUe) | Optional | Identifies the UE IDs |
| | | | for which the AIMLE |
| | | | server change is to be |
| | | | completed |
| tAimleServerId | string | Mandatory | Identifies the AIMLE |
| | | | server that will be the |
| | | | target AIMLE server |
| aimleServiceId | string | Optional | Identifies the AIMLE |
| | | | service for which the |
| | | | AIMLE server is |
| | | | changed |
| plmnId | PlmnIdNid | Optional | Identifies the roaming |
| | | | PLMN |
| aimleSrvMig | AimleSrvContType | Mandatory | Identifies type of the |
| | | | AIMLE service |
| | | | continuity |

In step 2a, upon receipt of the HTTP POST request, the AIMLE client 504 verifies the identity of the service consumer 502 and determines if the service consumer 502 is authorized for the request. If the service consumer 502 is authorized and the HTTP POST request is handled successfully, the AIMLE client 504 responds to the service consumer 502 with an HTTP 204 No Content status code, indicating that the server change complete message was successfully received and processed.

Alternatively, in step 2b, if the service consumer 502 is not authorized to request or if the HTTP POST request is not handled successfully, the AIMLE client 504 responds with an appropriate HTTP error status code in the 4xx or 5xx range. The AIMLE client 504 may also respond with an HTTP 307 Temporary Redirect status code or an HTTP 308 Permanent Redirect status code including a Location header containing an alternative URI of an alternative AIMLE client towards which the request may be redirected.

The signaling diagram 500 illustrates the server change complete operation, which is a custom API operation without associated resources used to inform the AIMLE client 404 of the selected target AIMLE server for service migration when a UE roams to a visited PLMN. Upon receiving the server change complete message, the AIMLE client 404 may confirm and connect to the target AIMLE server via the source AIMLE server for continuity of the ML operation. Based on successful AIMLE server migration, an AIMLE context transfer procedure may follow.

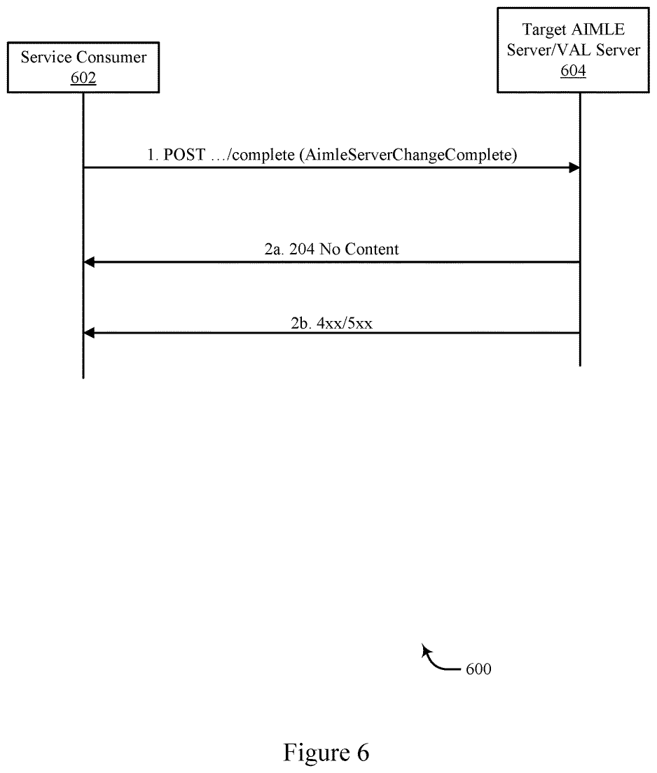

FIG. 6 illustrates a signaling diagram 600 in accordance with aspects of the present disclosure. In some examples, the signaling diagram 600 implements or is implemented by aspects of the wireless communications system 100 and the signaling diagram 200. The signaling diagram 600 includes a service consumer 602 and a target AIMLE server/VAL server 604, which may be examples of the source AIMLE server 206 and the target AIMLE server 202 and/or the VAL server 208, respectively, as described with reference to FIG. 2. The service consumer 602 and the target AIMLE server/VAL server 604 may implement or be implemented by one or more NEs 102. Alternative examples of the following may be implemented, where some processes are performed in a different order than described or are not performed. In some cases, processes may include additional features not mentioned below, or further processes may be added.

The signaling diagram 600 depicts the interactions between the service consumer 602 and the target AIMLE server/VAL server 604 for notifying completion of a cross-PLMN AIMLE server change. The AIMLE server change notification is performed using the second API (e.g., the AIMLES\ ServiceMigration API) described with reference to FIGS. 2, 4, and 5. The AIMLES\_ServiceMigration API, when exposed by the target AIMLE server and the VAL server, enables a service consumer to notify the target AIMLE server and the VAL server of the completion of a cross-PLMN AIMLE server change. The AIMLES\ ServiceMigration API defines a server change notification operation (e.g., AIMLES\_AIMLEServerChange\_Notify) that reuses the same server change complete custom operation and the same server change complete data structure (e.g., AimleServerChangeComplete) as described with reference to FIG. 5. The server change notification operation is a custom operation without associated resources.

In step 1, the service consumer 602 transmits an HTTP POST request to the target AIMLE server/VAL server 604 targeting the URI of the server change complete operation (e.g., {apiRoot}/aimlec-smig/v1/complete). The request body includes the server change complete data structure (e.g., AimleServerChangeComplete) as described with reference to FIG. 5. The server change complete data structure contains an AIMLE client identifier identifying the AIMLE client, UE identifiers identifying the UEs for which the AIMLE server change is to be completed, a target AIMLE server identifier identifying the target AIMLE server, an AIMLE service identifier identifying the AIMLE service for which the AIMLE server is changed, a roaming PLMN identifier identifying the visited PLMN, and a type of AIMLE service continuity indicating whether the service continuity is based on migration or relaying.

In step 2a, upon successful processing of the request, the target AIMLE server/VAL server 604 responds to the service consumer 602 with an HTTP 204 No Content status code, indicating that the server change notification has been successfully received and processed.

Alternatively, in step 2b, if the request is not handled successfully or an error occurs, the target AIMLE server/VAL server 604 responds with an appropriate HTTP error status code in the 4xx or 5xx range to indicate the failure condition.

The signaling diagram 600 illustrates how the service consumer 602 uses the server change complete operation to notify the target AIMLE server/VAL server 604 of an expected change of the AIMLE server from a source AIMLE server to a target AIMLE server in a visited PLMN. The same server change complete operation used to notify the AIMLE client of the server change completion, as described with reference to FIG. 5, is reused to notify the target AIMLE server and the VAL server of the migration. This reuse enables coordinated service continuity when a UE roams to a visited PLMN using a single custom operation and a single data structure across multiple recipient entities. Upon receiving the server change notification, the target AIMLE server may establish a connection with the AIMLE client for service continuity. For example, the target AIMLE server may prepare to receive connections from the AIMLE client and may allocate resources for the ML operation to be migrated or relayed.

For the AIMLES\ ServiceMigration API, HTTP error responses may be supported in accordance with applicable error handling provisions. Protocol errors and application errors may be supported for the HTTP status codes applicable to the AIMLES\ ServiceMigration API. The AIMLES\_ServiceMigration API may support feature negotiation using an extensibility mechanism. Security provisions may apply to the AIMLES\_ServiceMigration API.

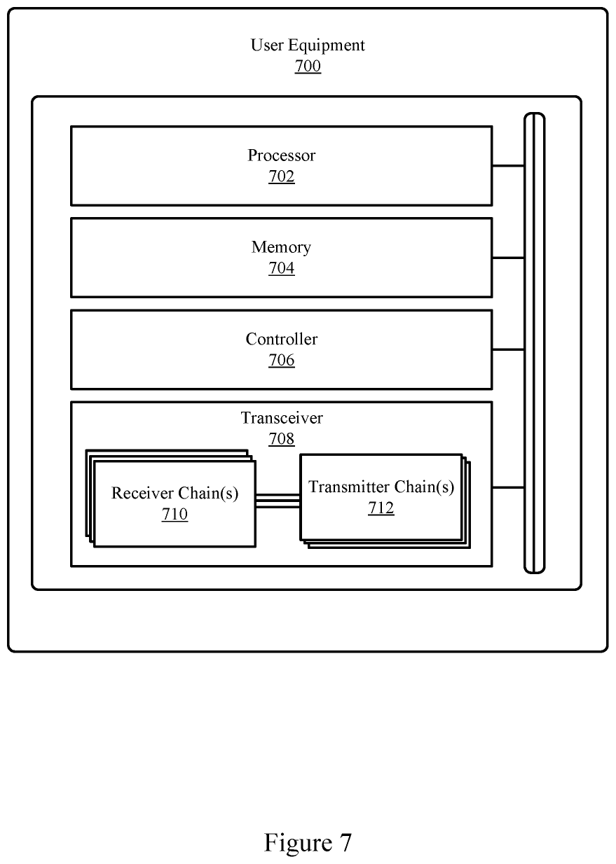

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces. The UE 700 may include or may be an example of an AIMLE client as described herein. For example, the UE 700 may implement an AIMLE client that interfaces with an AIMLE server to request and manage ML operations on behalf of a VAL application.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a central processing unit (CPU), an ASIC, a field-programmable gate-array (FPGA), or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions when executed by the processor 702 cause the UE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the functions described herein (e.g., executing, by the processor 702, instructions stored in the memory 704). For example, the processor 702 may support wireless communication at the UE 700 in accordance with examples as disclosed herein. The UE 700 may be configured to or operable to support a means for receiving, from a source AIMLE server via a custom server change trigger operation, a server change trigger request including a first list of AIMLE servers available in a visited PLMN, where the AIMLE client is associated with a UE moving to the visited PLMN, transmitting, to the source AIMLE server, a server change trigger response indicating a second list of AIMLE servers including a subset of the first list of AIMLE servers, and receiving, from the source AIMLE server via a custom server change complete operation, a server change complete message indicating an AIMLE server selected from the second list of AIMLE servers. In this manner, the UE 700 supports AIMLE service migration by participating in the server selection process when roaming to a visited PLMN, which may reduce service disruption and maintain continuity of ML operations.

Additionally, the UE 700 may be configured to support any one or combination of the custom server change trigger operation and the custom server change complete operation are custom API operations without associated resources. This aspect may reduce signaling overhead and processing complexity at the UE 700 by avoiding creation or management of persistent resources at the API endpoints.

Additionally, or alternatively, the UE 700 may be configured to support any one or combination of connecting to the AIMLE server for service migration. This aspect may enable the UE 700 to establish connectivity with the target AIMLE server for continuity of the ML operation after the server change is completed.

Additionally, or alternatively, the UE 700 may be configured to support any one or combination of detecting mobility of the UE to an area covered by the visited PLMN, and transmitting, to the source AIMLE server, an indication of the mobility, where the server change trigger request is received based on the indication of the mobility. This aspect may enable proactive initiation of the service migration procedure before the UE 700 loses connectivity to the source AIMLE server, reducing the likelihood of service interruption.

Additionally, or alternatively, the UE 700 may support at least one memory (e.g., the memory 704) and at least one processor (e.g., the processor 702) coupled with the at least one memory and configured to cause the UE 700 to receive, from a source AIMLE server via a custom server change trigger operation, a server change trigger request including a first list of AIMLE servers available in a visited PLMN, where the AIMLE client is associated with a UE moving to the visited PLMN, transmit, to the source AIMLE server, a server change trigger response indicating a second list of AIMLE servers including a subset of the first list of AIMLE servers, and receive, from the source AIMLE server via a custom server change complete operation, a server change complete message indicating an AIMLE server selected from the second list of AIMLE servers. In this manner, the UE 700 supports AIMLE service migration by participating in the server selection process when roaming to a visited PLMN, which may reduce service disruption and maintain continuity of ML operations.

Additionally, the UE 700 may be configured to support any one or combination of the custom server change trigger operation and the custom server change complete operation are custom API operations without associated resources. This aspect may reduce signaling overhead and processing complexity at the UE 700 by avoiding creation or management of persistent resources at the API endpoints.

Additionally, or alternatively, the UE 700 may be configured to support any one or combination of the at least one processor is operable to cause the UE 700 to connect to the AIMLE server for service migration. This aspect may enable the UE 700 to establish connectivity with the target AIMLE server for continuity of the ML operation after the server change is completed.

Additionally, or alternatively, the UE 700 may be configured to support any one or combination of the at least one processor is operable to cause the UE 700 to detect mobility of the UE to an area covered by the visited PLMN, and transmit, to the source AIMLE server, an indication of the mobility, where the server change trigger request is received based on the indication of the mobility. This aspect may enable proactive initiation of the service migration procedure before the UE 700 loses connectivity to the source AIMLE server, reducing the likelihood of service interruption.

The controller 706 may manage input and output signals for the UE 700. The controller 706 may also manage peripherals not integrated into the UE 700. In some implementations, the controller 706 may utilize an operating system such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

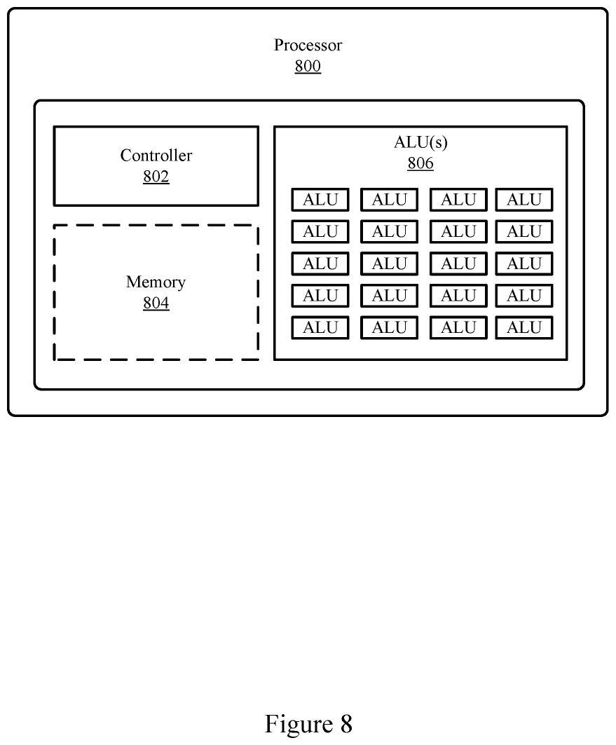

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may include or may be an example of, or may be a component of, one or more of a source AIMLE server, a target AIMLE server, an AIMLE client, an ML repository, or a VAL server as described herein. For example, the processor 800 may be a component of a source AIMLE server that initiates AIMLE service migration procedures, a target AIMLE server that establishes connections with AIMLE clients for service continuity, an AIMLE client that interfaces with an AIMLE server to request and manage ML operations, an ML repository that stores information about available AIMLE servers and responds to cross-PLMN AIMLE server discovery requests, or a VAL server that manages vertical application services and receives AIMLE server change notifications.

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory addresses of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, ALUs 806, and other functional units of the processor 800.

The memory 804 may include one or more caches (e.g., memory local to or included in the processor 800 or other memory, such as RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, and the controller 802, and may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 may be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

The processor 800 may support wireless communication in accordance with examples as disclosed herein. The processor 800 may be configured to or operable to support at least one controller (e.g., the controller 802) coupled with at least one memory (e.g., the memory 804) and configured to cause the processor to transmit, to an ML repository via a custom server discovery request operation, a cross-PLMN AIMLE server discovery request indicating one or more parameters for AIMLE server discovery for an AIMLE client associated with a UE moving to a visited PLMN, receive, from the ML repository, a server discovery response including a first list of AIMLE servers available in the visited PLMN based on the one or more parameters, transmit, to the AIMLE client via a custom server change trigger operation, a server change trigger request including the first list of AIMLE servers, receive, from the AIMLE client, a server change trigger response indicating a second list of AIMLE servers including a subset of the first list of AIMLE servers, and transmit, to the AIMLE client via a custom server change complete operation, a server change complete message indicating an AIMLE server selected from the second list of AIMLE servers. In this manner, the processor 800 supports AIMLE service migration from the source AIMLE server perspective by discovering available servers, triggering the AIMLE client to participate in server selection, and completing the server change, which may reduce service disruption and maintain continuity of ML operations when a UE roams to a visited PLMN.

Additionally, the processor 800 may be configured to support any one or combination of transmitting, to the AIMLE server and a VAL server, the server change complete message as part of the custom server change complete operation. This aspect may enable coordinated notification of the target AIMLE server and the VAL server, facilitating service continuity across multiple entities.

Additionally, or alternatively, the processor 800 may be configured to support any one or combination of the custom server discovery request operation, the custom server change trigger operation, and the custom server change complete operation are custom API operations without associated resources. This aspect may reduce signaling overhead and processing complexity by avoiding creation or management of persistent resources at the API endpoints.

Additionally, or alternatively, the processor 800 may be configured to support any one or combination of the cross-PLMN AIMLE server discovery request further indicates a requester identifier identifying the source AIMLE server. This aspect may enable the ML repository to identify and authenticate the requesting entity.

Additionally, or alternatively, the processor 800 may be configured to support any one or combination of the server discovery response further includes information associated with AIMLE-supported tasks. This aspect may enable the source AIMLE server to evaluate candidate AIMLE servers based on their supported task capabilities.

Additionally, or alternatively, the processor 800 may be configured to support any one or combination of the server change trigger request further indicates at least one of an AIMLE service identifier, one or more UE identifiers, a roaming PLMN identifier, or a type of AIMLE service continuity. This aspect may enable the AIMLE client to make informed server selection decisions based on service-specific and UE-specific information.

Additionally, or alternatively, the processor 800 may be configured to support any one or combination of the server change trigger request further includes context information associated with the first list of AIMLE servers, the context information including at least one of a server capability, a coverage area, a load and energy status, or a server ranking. This aspect may enable the AIMLE client to evaluate and down-select from the candidate AIMLE servers based on relevant context.

Additionally, or alternatively, the processor 800 may be configured to support any one or combination of selecting the AIMLE server from the second list of AIMLE servers based on the context information. This aspect may enable informed target server selection that considers server capabilities, coverage, load, and ranking.

Additionally, or alternatively, the processor 800 may be configured to support any one or combination of the server change complete message further indicates at least one of an AIMLE client identifier, one or more UE identifiers, a roaming PLMN identifier, or a type of AIMLE service continuity. This aspect may enable the AIMLE client and target AIMLE server to identify the specific service migration context.

Additionally, or alternatively, the processor 800 may be configured to support any one or combination of the one or more parameters include at least one of a geographical area, a server capability, a load and energy efficiency, or a server ranking. This aspect may enable targeted discovery of AIMLE servers that satisfy specific requirements, improving the efficiency of the server selection process.

Additionally, or alternatively, the processor 800 may be configured to support any one or combination of receiving, from the AIMLE client, an indication of mobility of the UE to an area covered by the visited PLMN, and the cross-PLMN AIMLE server discovery request is transmitted based on the indication of mobility. This aspect may enable proactive initiation of the service migration procedure before the UE loses connectivity to the source AIMLE server.

Additionally, or alternatively, the processor 800 may be configured to or operable to support at least one controller (e.g., the controller 802) coupled with at least one memory (e.g., the memory 804) and configured to cause the processor to receive, from a source AIMLE server via a custom server change trigger operation, a server change trigger request including a first list of AIMLE servers available in a visited PLMN, where the AIMLE client is associated with a UE moving to the visited PLMN, transmit, to the source AIMLE server, a server change trigger response indicating a second list of AIMLE servers including a subset of the first list of AIMLE servers, and receive, from the source AIMLE server via a custom server change complete operation, a server change complete message indicating an AIMLE server selected from the second list of AIMLE servers. In this manner, the processor 800 supports AIMLE service migration from the AIMLE client perspective by participating in the server selection process when roaming to a visited PLMN, which may reduce service disruption and maintain continuity of ML operations.

Additionally, the processor 800 may be configured to support any one or combination of the custom server change trigger operation and the custom server change complete operation are custom API operations without associated resources. This aspect may reduce signaling overhead and processing complexity at the processor 800 by avoiding creation or management of persistent resources at the API endpoints.

Additionally, or alternatively, the processor 800 may be configured to support any one or combination of connecting to the AIMLE server for service migration. This aspect may enable the processor 800 to establish connectivity with the target AIMLE server for continuity of the ML operation after the server change is completed.

Additionally, or alternatively, the processor 800 may be configured to support any one or combination of detecting mobility of the UE to an area covered by the visited PLMN, and transmitting, to the source AIMLE server, an indication of the mobility, where the server change trigger request is received based on the indication of the mobility. This aspect may enable proactive initiation of the service migration procedure before the processor 800 loses connectivity to the source AIMLE server, reducing the likelihood of service interruption.

Additionally, or alternatively, the processor 800 may be configured to or operable to support at least one controller (e.g., the controller 802) coupled with at least one memory (e.g., the memory 804) and configured to cause the processor to receive, from a source AIMLE server via a custom server discovery request operation, a cross-PLMN AIMLE server discovery request indicating one or more parameters for AIMLE server discovery, and transmit, to the source AIMLE server, a server discovery response including a first list of the AIMLE servers available in a visited PLMN based on the one or more parameters. In this manner, the processor 800 supports AIMLE service migration from the ML repository perspective by responding to cross-PLMN AIMLE server discovery requests with available server information, which may enable the source AIMLE server to identify suitable target servers in the visited PLMN.

Additionally, the processor 800 may be configured to support any one or combination of the custom server discovery request operation is a custom API operation without associated resources. This aspect may reduce signaling overhead and processing complexity by avoiding creation or management of persistent resources at the API endpoint.

Additionally, or alternatively, the processor 800 may be configured to support any one or combination of the one or more parameters include at least one of a geographical area, a server capability, a load and energy efficiency, or a server ranking. This aspect may enable targeted discovery of AIMLE servers that satisfy specific requirements, improving the efficiency of the server selection process.

Additionally, or alternatively, the processor 800 may be configured to or operable to support at least one controller (e.g., the controller 802) coupled with at least one memory (e.g., the memory 804) and configured to cause the processor to receive, from a source AIMLE server via a custom server change complete operation, a server change complete message indicating an AIMLE server change for an AIMLE client from the source AIMLE server to the target AIMLE server, and establish a connection with the AIMLE client for service continuity. In this manner, the processor 800 supports AIMLE service migration from the target AIMLE server perspective by receiving the server change notification and establishing connectivity with the AIMLE client, which may enable continuity of ML operations in the visited PLMN.

Additionally, the processor 800 may be configured to support any one or combination of the custom server change complete operation is a custom API operation without associated resources. This aspect may reduce signaling overhead and processing complexity by avoiding creation or management of persistent resources at the API endpoint.

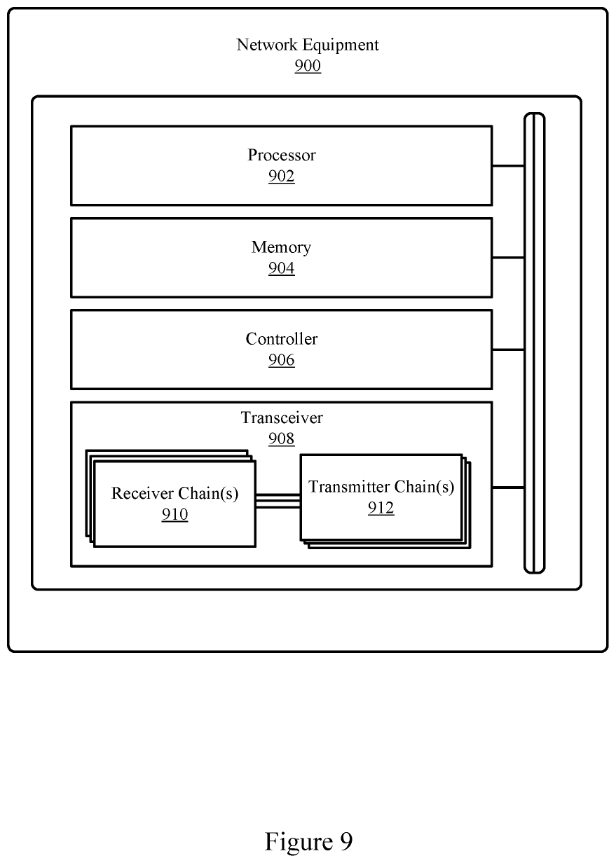

FIG. 9 illustrates an example of an NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The NE 900 may include or may be an example of a source AIMLE server, a target AIMLE server, an ML repository, or a VAL server as described herein. For example, the NE 900 may implement one or more of a source AIMLE server that initiates AIMLE service migration procedures, a target AIMLE server that receives AIMLE service migration notifications and establishes connections with AIMLE clients for service continuity, an ML repository that stores information about available AIMLE servers and responds to cross-PLMN AIMLE server discovery requests, or a VAL server that manages vertical application services and receives AIMLE server change notifications.

The processor 902, the memory 904, the controller 906, or the transceiver 908, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the functions described herein (e.g., executing, by the processor 902, instructions stored in the memory 904). For example, the processor 902 may support wireless communication at the NE 900 in accordance with examples as disclosed herein. The NE 900 may be configured to or operable to support a means for transmitting, to an ML repository via a custom server discovery request operation, a cross-PLMN AIMLE server discovery request indicating one or more parameters for AIMLE server discovery for an AIMLE client associated with a UE moving to a visited PLMN, receiving, from the ML repository, a server discovery response including a first list of AIMLE servers available in the visited PLMN based on the one or more parameters, transmitting, to the AIMLE client via a custom server change trigger operation, a server change trigger request including the first list of AIMLE servers, receiving, from the AIMLE client, a server change trigger response indicating a second list of AIMLE servers including a subset of the first list of AIMLE servers, and transmitting, to the AIMLE client via a custom server change complete operation, a server change complete message indicating an AIMLE server selected from the second list of AIMLE servers. In this manner, the NE 900 supports AIMLE service migration from the source AIMLE server perspective by coordinating discovery of available AIMLE servers, triggering server selection at the AIMLE client, and completing the server change, which may reduce service disruption and maintain continuity of ML operations when a UE roams to a visited PLMN.

Additionally, the NE 900 may be configured to support any one or combination of transmitting, to the AIMLE server and a VAL server, the server change complete message as part of the custom server change complete operation. This aspect may enable coordinated notification of the target AIMLE server and the VAL server, reducing the risk of conflicting state between entities during the migration.

Additionally, or alternatively, the NE 900 may be configured to support any one or combination of the custom server discovery request operation, the custom server change trigger operation, and the custom server change complete operation are custom API operations without associated resources. This aspect may reduce signaling overhead and processing complexity by avoiding creation or management of persistent resources at the API endpoints.

Additionally, or alternatively, the NE 900 may be configured to support any one or combination of the cross-PLMN AIMLE server discovery request further indicates a requester identifier identifying the source AIMLE server. This aspect may enable the ML repository to verify the identity and authorization of the requesting entity.

Additionally, or alternatively, the NE 900 may be configured to support any one or combination of the server discovery response further includes information associated with AIMLE-supported tasks. This aspect may enable the source AIMLE server to evaluate the task capabilities of available AIMLE servers.

Additionally, or alternatively, the NE 900 may be configured to support any one or combination of the server change trigger request further indicates at least one of an AIMLE service identifier, one or more UE identifiers, a roaming PLMN identifier, or a type of AIMLE service continuity. This aspect may enable the AIMLE client to identify the specific service and UEs affected by the migration.

Additionally, or alternatively, the NE 900 may be configured to support any one or combination of the server change trigger request further includes context information associated with the first list of AIMLE servers, the context information including at least one of a server capability, a coverage area, a load and energy status, or a server ranking. This aspect may enable the AIMLE client to make informed down-selection decisions based on server attributes.

Additionally, or alternatively, the NE 900 may be configured to support any one or combination of selecting the AIMLE server from the second list of AIMLE servers based on the context information. This aspect may enable the source AIMLE server to make a final target server determination that accounts for both the AIMLE client's preferences and the context information.

Additionally, or alternatively, the NE 900 may be configured to support any one or combination of the server change complete message further indicates at least one of an AIMLE client identifier, one or more UE identifiers, a roaming PLMN identifier, or a type of AIMLE service continuity. This aspect may enable the AIMLE client to identify the specific parameters of the completed migration.

Additionally, or alternatively, the NE 900 may be configured to support any one or combination of the one or more parameters include at least one of a geographical area, a server capability, a load and energy efficiency, or a server ranking. This aspect may enable targeted discovery of AIMLE servers that satisfy specific requirements.

Additionally, or alternatively, the NE 900 may be configured to support any one or combination of receiving, from the AIMLE client, an indication of mobility of the UE to an area covered by the visited PLMN, and the cross-PLMN AIMLE server discovery request is transmitted based on the indication of mobility. This aspect may enable proactive initiation of the service migration procedure before the UE loses connectivity to the source AIMLE server.

Additionally, or alternatively, the NE 900 may support at least one memory (e.g., the memory 904) and at least one processor (e.g., the processor 902) coupled with the at least one memory and configured to cause the NE 900 to transmit, to an ML repository via a custom server discovery request operation, a cross-PLMN AIMLE server discovery request indicating one or more parameters for AIMLE server discovery for an AIMLE client associated with a UE moving to a visited PLMN, receive, from the ML repository, a server discovery response including a first list of AIMLE servers available in the visited PLMN based on the one or more parameters, transmit, to the AIMLE client via a custom server change trigger operation, a server change trigger request including the first list of AIMLE servers, receive, from the AIMLE client, a server change trigger response indicating a second list of AIMLE servers including a subset of the first list of AIMLE servers, and transmit, to the AIMLE client via a custom server change complete operation, a server change complete message indicating an AIMLE server selected from the second list of AIMLE servers. In this manner, the NE 900 supports AIMLE service migration from the source AIMLE server perspective by coordinating discovery of available AIMLE servers, triggering server selection at the AIMLE client, and completing the server change, which may reduce service disruption and maintain continuity of ML operations when a UE roams to a visited PLMN.

Additionally, the NE 900 may be configured to support any one or combination of the at least one processor is operable to cause the NE 900 to transmit, to the AIMLE server and a VAL server, the server change complete message as part of the custom server change complete operation. This aspect may enable coordinated notification of the target AIMLE server and the VAL server.

Additionally, or alternatively, the NE 900 may be configured to support any one or combination of the custom server discovery request operation, the custom server change trigger operation, and the custom server change complete operation are custom API operations without associated resources. This aspect may reduce signaling overhead and processing complexity by avoiding creation or management of persistent resources at the API endpoints.

Additionally, or alternatively, the NE 900 may be configured to support any one or combination of the cross-PLMN AIMLE server discovery request further indicates a requester identifier identifying the source AIMLE server. This aspect may enable the ML repository to verify the identity and authorization of the requesting entity.

Additionally, or alternatively, the NE 900 may be configured to support any one or combination of the server discovery response further includes information associated with AIMLE-supported tasks. This aspect may enable the source AIMLE server to evaluate the task capabilities of available AIMLE servers.

Additionally, or alternatively, the NE 900 may be configured to support any one or combination of the server change trigger request further indicates at least one of an AIMLE service identifier, one or more UE identifiers, a roaming PLMN identifier, or a type of AIMLE service continuity. This aspect may enable the AIMLE client to identify the specific service and UEs affected by the migration.

Additionally, or alternatively, the NE 900 may be configured to support any one or combination of the server change trigger request further includes context information associated with the first list of AIMLE servers, the context information including at least one of a server capability, a coverage area, a load and energy status, or a server ranking. This aspect may enable the AIMLE client to make informed down-selection decisions based on server attributes.

Additionally, or alternatively, the NE 900 may be configured to support any one or combination of the at least one processor is operable to cause the NE 900 to select the AIMLE server from the second list of AIMLE servers based on the context information. This aspect may enable the source AIMLE server to make a final target server determination.

Additionally, or alternatively, the NE 900 may be configured to support any one or combination of the server change complete message further indicates at least one of an AIMLE client identifier, one or more UE identifiers, a roaming PLMN identifier, or a type of AIMLE service continuity. This aspect may enable the AIMLE client to identify the specific parameters of the completed migration.

Additionally, or alternatively, the NE 900 may be configured to support any one or combination of the one or more parameters include at least one of a geographical area, a server capability, a load and energy efficiency, or a server ranking. This aspect may enable targeted discovery of AIMLE servers that satisfy specific requirements.

Additionally, or alternatively, the NE 900 may be configured to support any one or combination of the at least one processor is operable to cause the NE 900 to receive, from the AIMLE client, an indication of mobility of the UE to an area covered by the visited PLMN, and the cross-PLMN AIMLE server discovery request is transmitted based on the indication of mobility. This aspect may enable proactive initiation of the service migration procedure before the UE loses connectivity to the source AIMLE server.

Additionally, or alternatively, the NE 900 may be configured to or operable to support a means for receiving, from a source AIMLE server via a custom server discovery request operation, a cross-PLMN AIMLE server discovery request indicating one or more parameters for AIMLE server discovery, and transmitting, to the source AIMLE server, a server discovery response including a first list of the AIMLE servers available in a visited PLMN based on the one or more parameters. In this manner, the NE 900 supports cross-PLMN AIMLE server discovery from the ML repository perspective by identifying available AIMLE servers that match the discovery parameters, which may enable the source AIMLE server to proceed with the service migration procedure.

Additionally, the NE 900 may be configured to support any one or combination of the custom server discovery request operation is a custom API operation without associated resources. This aspect may reduce signaling overhead and processing complexity by avoiding creation or management of persistent resources at the API endpoint.

Additionally, or alternatively, the NE 900 may be configured to support any one or combination of the one or more parameters include at least one of a geographical area, a server capability, a load and energy efficiency, or a server ranking. This aspect may enable targeted discovery of AIMLE servers that satisfy specific requirements.

Additionally, or alternatively, the NE 900 may support at least one memory (e.g., the memory 904) and at least one processor (e.g., the processor 902) coupled with the at least one memory and configured to cause the NE 900 to receive, from a source AIMLE server via a custom server discovery request operation, a cross-PLMN AIMLE server discovery request indicating one or more parameters for AIMLE server discovery, and transmit, to the source AIMLE server, a server discovery response including a first list of the AIMLE servers available in a visited PLMN based on the one or more parameters. In this manner, the NE 900 supports cross-PLMN AIMLE server discovery from the ML repository perspective by identifying available AIMLE servers that match the discovery parameters, which may enable the source AIMLE server to proceed with the service migration procedure.

Additionally, the NE 900 may be configured to support any one or combination of the custom server discovery request operation is a custom API operation without associated resources. This aspect may reduce signaling overhead and processing complexity by avoiding creation or management of persistent resources at the API endpoint.

Additionally, or alternatively, the NE 900 may be configured to support any one or combination of the one or more parameters include at least one of a geographical area, a server capability, a load and energy efficiency, or a server ranking. This aspect may enable targeted discovery of AIMLE servers that satisfy specific requirements.

Additionally, or alternatively, the NE 900 may be configured to or operable to support a means for receiving, from a source AIMLE server via a custom server change complete operation, a server change complete message indicating an AIMLE server change for an AIMLE client from the source AIMLE server to the target AIMLE server, and establishing a connection with the AIMLE client for service continuity. In this manner, the NE 900 supports AIMLE service migration from the target AIMLE server perspective by receiving the server change notification and establishing connectivity with the AIMLE client, which may enable continuity of ML operations in the visited PLMN.

Additionally, the NE 900 may be configured to support any one or combination of the custom server change complete operation is a custom API operation without associated resources. This aspect may reduce signaling overhead and processing complexity by avoiding creation or management of persistent resources at the API endpoint.

Additionally, or alternatively, the NE 900 may support at least one memory (e.g., the memory 904) and at least one processor (e.g., the processor 902) coupled with the at least one memory and configured to cause the NE 900 to receive, from a source AIMLE server via a custom server change complete operation, a server change complete message indicating an AIMLE server change for an AIMLE client from the source AIMLE server to the target AIMLE server, and establish a connection with the AIMLE client for service continuity. In this manner, the NE 900 supports AIMLE service migration from the target AIMLE server perspective by receiving the server change notification and establishing connectivity with the AIMLE client, which may enable continuity of ML operations in the visited PLMN.

Additionally, the NE 900 may be configured to support any one or combination of the custom server change complete operation is a custom API operation without associated resources. This aspect may reduce signaling overhead and processing complexity by avoiding creation or management of persistent resources at the API endpoint.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., an LNA) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

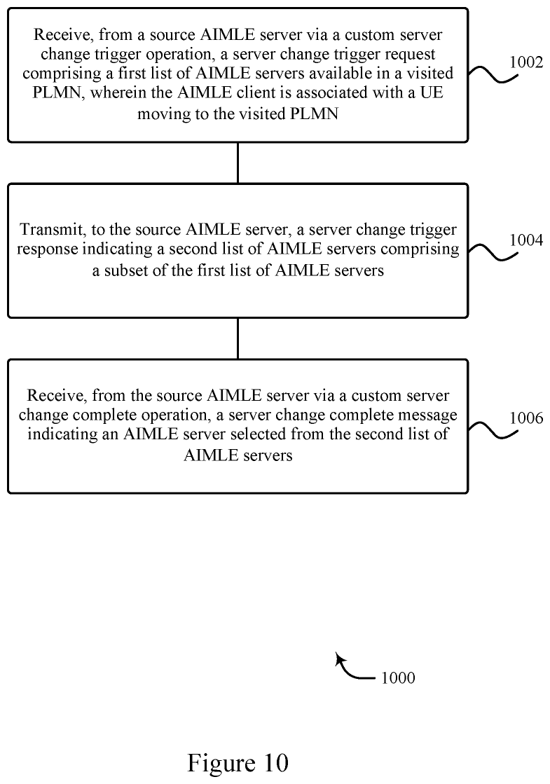

FIG. 10 illustrates a flowchart of a method 1000 in accordance with aspects of the present disclosure. The operations of the method may be implemented by an AIMLE client as described herein. In some implementations, the AIMLE client may be implemented by a UE, and the UE may execute a set of instructions to control the function elements of the UE to perform the described functions. It should be noted that the method described herein describes a possible implementation, and that the operations and the steps may be rearranged or otherwise modified and that other implementations are possible.

At 1002, the method may include receiving, from a source AIMLE server via a custom server change trigger operation, a server change trigger request including a first list of AIMLE servers available in a visited PLMN, where the AIMLE client is associated with a UE moving to the visited PLMN. The operations of 1002 may be performed in accordance with examples as described herein. In some implementations, aspects of the operations of 1002 may be performed by a UE as described with reference to FIG. 7.

At 1004, the method may include transmitting, to the source AIMLE server, a server change trigger response indicating a second list of AIMLE servers including a subset of the first list of AIMLE servers. The operations of 1004 may be performed in accordance with examples as described herein. In some implementations, aspects of the operations of 1004 may be performed by a UE as described with reference to FIG. 7.

At 1006, the method may include receiving, from the source AIMLE server via a custom server change complete operation, a server change complete message indicating an AIMLE server selected from the second list of AIMLE servers. The operations of 1006 may be performed in accordance with examples as described herein. In some implementations, aspects of the operations of 1006 may be performed by a UE as described with reference to FIG. 7.

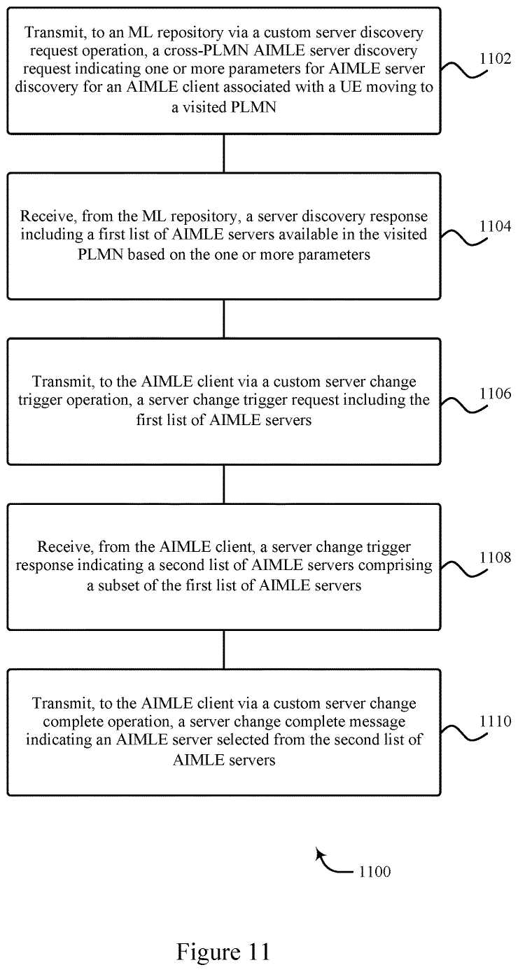

FIG. 11 illustrates a flowchart of a method 1100 in accordance with aspects of the present disclosure. The operations of the method may be implemented by a source AIMLE server as described herein. In some implementations, the source AIMLE server may be implemented by an NE, and the NE may execute a set of instructions to control the function elements of the NE to perform the described functions. It should be noted that the method described herein describes a possible implementation, and that the operations and the steps may be rearranged or otherwise modified and that other implementations are possible.

At 1102, the method may include transmitting, to an ML repository via a custom server discovery request operation, a cross-PLMN AIMLE server discovery request indicating one or more parameters for AIMLE server discovery for an AIMLE client associated with a UE moving to a visited PLMN. The operations of 1102 may be performed in accordance with examples as described herein. In some implementations, aspects of the operations of 1102 may be performed by an NE as described with reference to FIG. 9.

At 1104, the method may include receiving, from the ML repository, a server discovery response including a first list of AIMLE servers available in the visited PLMN based on the one or more parameters. The operations of 1104 may be performed in accordance with examples as described herein. In some implementations, aspects of the operations of 1104 may be performed by an NE as described with reference to FIG. 9.

At 1106, the method may include transmitting, to the AIMLE client via a custom server change trigger operation, a server change trigger request including the first list of AIMLE servers. The operations of 1106 may be performed in accordance with examples as described herein. In some implementations, aspects of the operations of 1106 may be performed by an NE as described with reference to FIG. 9.

At 1108, the method may include receiving, from the AIMLE client, a server change trigger response indicating a second list of AIMLE servers including a subset of the first list of AIMLE servers. The operations of 1108 may be performed in accordance with examples as described herein. In some implementations, aspects of the operations of 1108 may be performed by an NE as described with reference to FIG. 9.

At 1110, the method may include transmitting, to the AIMLE client via a custom server change complete operation, a server change complete message indicating an AIMLE server selected from the second list of AIMLE servers. The operations of 1110 may be performed in accordance with examples as described herein. In some implementations, aspects of the operations of 1110 may be performed by an NE as described with reference to FIG. 9.

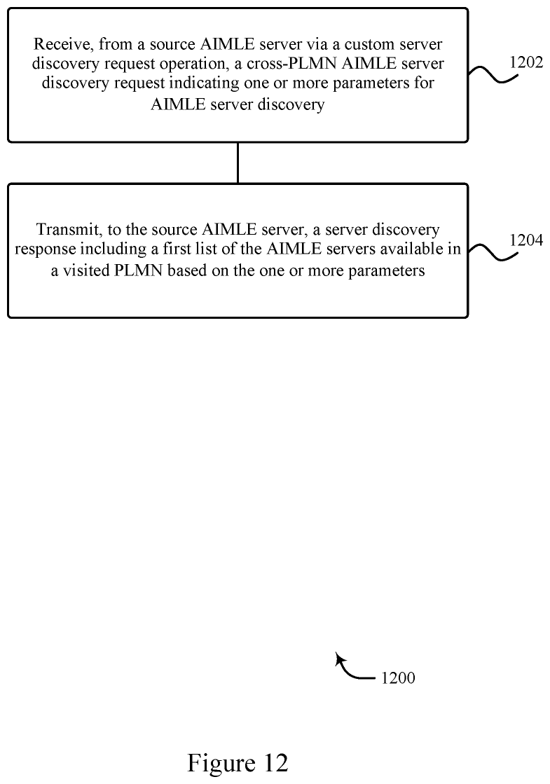

FIG. 12 illustrates a flowchart of a method 1200 in accordance with aspects of the present disclosure. The operations of the method may be implemented by an ML repository as described herein. In some implementations, the ML repository may be implemented by an NE, and the NE may execute a set of instructions to control the function elements of the NE to perform the described functions. It should be noted that the method described herein describes a possible implementation, and that the operations and the steps may be rearranged or otherwise modified and that other implementations are possible.

At 1202, the method may include receiving, from a source AIMLE server via a custom server discovery request operation, a cross-PLMN AIMLE server discovery request indicating one or more parameters for AIMLE server discovery. The operations of 1202 may be performed in accordance with examples as described herein. In some implementations, aspects of the operations of 1202 may be performed by an NE as described with reference to FIG. 9.

At 1204, the method may include transmitting, to the source AIMLE server, a server discovery response including a first list of the AIMLE servers available in a visited PLMN based on the one or more parameters. The operations of 1204 may be performed in accordance with examples as described herein. In some implementations, aspects of the operations of 1204 may be performed by an NE as described with reference to FIG. 9.

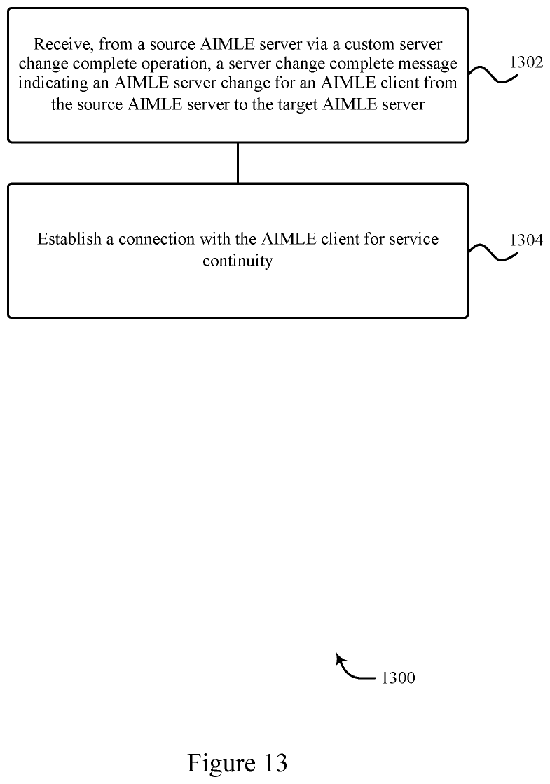

FIG. 13 illustrates a flowchart of a method 1300 in accordance with aspects of the present disclosure. The operations of the method may be implemented by a target AIMLE server as described herein. In some implementations, the target AIMLE server may be implemented by an NE, and the NE may execute a set of instructions to control the function elements of the NE to perform the described functions. It should be noted that the method described herein describes a possible implementation, and that the operations and the steps may be rearranged or otherwise modified and that other implementations are possible.

At 1302, the method may include receiving, from a source AIMLE server via a custom server change complete operation, a server change complete message indicating an AIMLE server change for an AIMLE client from the source AIMLE server to the target AIMLE server. The operations of 1302 may be performed in accordance with examples as described herein. In some implementations, aspects of the operations of 1302 may be performed by an NE as described with reference to FIG. 9.

At 1304, the method may include establishing a connection with the AIMLE client for service continuity. The operations of 1304 may be performed in accordance with examples as described herein. In some implementations, aspects of the operations of 1304 may be performed by an NE as described with reference to FIG. 9.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A source artificial intelligence machine learning enablement (AIMLE) server, comprising:
one or more memories; and
one or more processors coupled with the one or more memories and individually or collectively operable to cause the source AIMLE server to:
transmit, to a machine learning (ML) repository via a custom server discovery request operation, a cross-public land mobile network (PLMN) AIMLE server discovery request indicating one or more parameters for AIMLE server discovery for an AIMLE client associated with a user equipment (UE) moving to a visited PLMN;
receive, from the ML repository, a server discovery response including a first list of AIMLE servers available in the visited PLMN based at least in part on the one or more parameters;
transmit, to the AIMLE client via a custom server change trigger operation, a server change trigger request including the first list of AIMLE servers;
receive, from the AIMLE client, a server change trigger response indicating a second list of AIMLE servers comprising a subset of the first list of AIMLE servers; and
transmit, to the AIMLE client via a custom server change complete operation, a server change complete message indicating an AIMLE server selected from the second list of AIMLE servers.

2. The source AIMLE server of claim 1, wherein the one or more processors are further operable to cause the source AIMLE server to transmit, to the AIMLE server and a vertical application layer (VAL) server, the server change complete message as part of the custom server change complete operation.

3. The source AIMLE server of claim 1, wherein the custom server discovery request operation, the custom server change trigger operation, and the custom server change complete operation are custom application programming interface (API) operations without associated resources.

4. The source AIMLE server of claim 1, wherein the cross-PLMN AIMLE server discovery request further indicates a requester identifier identifying the source AIMLE server.

5. The source AIMLE server of claim 1, wherein the server discovery response further includes information associated with AIMLE-supported tasks.

6. The source AIMLE server of claim 1, wherein the server change trigger request further indicates at least one of an AIMLE service identifier, one or more UE identifiers, a roaming PLMN identifier, or a type of AIMLE service continuity.

7. The source AIMLE server of claim 1, wherein the server change trigger request further includes context information associated with the first list of AIMLE servers, the context information including at least one of a server capability, a coverage area, a load and energy status, or a server ranking.

8. The source AIMLE server of claim 7, wherein the one or more processors are further operable to cause the source AIMLE server to select the AIMLE server from the second list of AIMLE servers based at least in part on the context information.

9. The source AIMLE server of claim 1, wherein the server change complete message further indicates at least one of an AIMLE client identifier, one or more UE identifiers, a roaming PLMN identifier, or a type of AIMLE service continuity.

10. The source AIMLE server of claim 1, wherein the one or more parameters comprise at least one of a geographical area, a server capability, a load and energy efficiency, or a server ranking.

11. The source AIMLE server of claim 1, wherein the one or more processors are further operable to cause the source AIMLE server to receive, from the AIMLE client, an indication of mobility of the UE to an area covered by the visited PLMN, and wherein the cross-PLMN AIMLE server discovery request is transmitted based at least in part on the indication of mobility.

12. An artificial intelligence machine learning enablement (AIMLE) client, comprising:
one or more memories; and
one or more processors coupled with the one or more memories and individually or collectively operable to cause the AIMLE client to:
receive, from a source AIMLE server via a custom server change trigger operation, a server change trigger request comprising a first list of AIMLE servers available in a visited public land mobile network (PLMN), wherein the AIMLE client is associated with a user equipment (UE) moving to the visited PLMN;
transmit, to the source AIMLE server, a server change trigger response indicating a second list of AIMLE servers comprising a subset of the first list of AIMLE servers; and
receive, from the source AIMLE server via a custom server change complete operation, a server change complete message indicating an AIMLE server selected from the second list of AIMLE servers.

13. The AIMLE client of claim 12, wherein the custom server change trigger operation and the custom server change complete operation are custom application programming interface (API) operations without associated resources.

14. The AIMLE client of claim 12, wherein the one or more processors are further operable to cause the AIMLE client to connect to the AIMLE server for service migration.

15. The AIMLE client of claim 12, wherein the one or more processors are further operable to cause the AIMLE client to:
detect mobility of the UE to an area covered by the visited PLMN; and
transmit, to the source AIMLE server, an indication of the mobility, wherein the server change trigger request is received based at least in part on the indication of the mobility.

16. A machine learning (ML) repository, comprising:
one or more memories; and
one or more processors coupled with the one or more memories and individually or collectively operable to cause the ML repository to:
receive, from a source artificial intelligence machine learning enablement (AIMLE) server via a custom server discovery request operation, a cross-public land mobile network (PLMN) AIMLE server discovery request indicating one or more parameters for AIMLE server discovery; and
transmit, to the source AIMLE server, a server discovery response including a first list of the AIMLE servers available in a visited PLMN based at least in part on the one or more parameters.

17. The ML repository of claim 16, wherein the custom server discovery request operation is a custom application programming interface (API) operation without associated resources.

18. The ML repository of claim 16, wherein the one or more parameters comprise at least one of a geographical area, a server capability, a load and energy efficiency, or a server ranking.

19. A target artificial intelligence machine learning enablement (AIMLE) server, comprising:
one or more memories; and
one or more processors coupled with the one or more memories and individually or collectively operable to cause the target AIMLE server to:
receive, from a source AIMLE server via a custom server change complete operation, a server change complete message indicating an AIMLE server change for an AIMLE client from the source AIMLE server to the target AIMLE server; and
establish a connection with the AIMLE client for service continuity.

20. The target AIMLE server of claim 19, wherein the custom server change complete operation is a custom application programming interface (API) operation without associated resources.
